(19) United States
(12) Patent Application Publication
(10) Pub. No.: US 2026/0291703 A1
(43) Pub. Date: Sep. 24, 2026

(54) DUPLEX PATTERN CONFIGURATIONS FOR TIME DIVISION DUPLEX PATTERNS AND SUB-BAND FULL DUPLEX PATTERNS

(71) Applicant: QUALCOMM Incorporated, San Diego, CA (US)

(72) Inventors: Muhammad Sayed Khairy ABDELGHAFFAR, San Jose, CA (US); Mohammed JABI, San Diego, CA (US); Abdelrahman Mohamed IBRAHIM, San Diego, CA (US); Ahmed Attia ABOTABL, San Diego, CA (US)

(21) Appl. No.: 19/084,139

(22) Filed: Mar. 19, 2025

(51) Int. Cl. H04L 5/14; H04L 5/00; H04L 27/26

(52) U.S. Cl. CPC H04L 5/14; H04L 5/0044; H04L 27/2656

(57) ABSTRACT

Various aspects of the present disclosure generally relate to wireless communication. In some aspects, a user equipment (UE) may receive configuration information indicating a first duplex pattern associated with a network node, wherein the first duplex pattern is associated with a format capable of being configured as one or more of time division duplex (TDD) patterns or sub-band full duplex (SBFD) patterns, and wherein the configuration information indicates, as the first duplex pattern, at least one of a first selected TDD pattern associated with the network node or a first selected SBFD pattern associated with the network node. The UE may communicate with the network node based at least in part on the configuration information. Numerous other aspects are described.

### FIELD OF THE DISCLOSURE

Aspects of the present disclosure generally relate to wireless communication and specifically relate to techniques, apparatuses, and methods associated with duplex pattern configurations for time division duplex patterns and sub-band full duplex patterns.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

In some examples, wireless communication devices may be capable of sub-band full duplex (SBFD) communication, which may also be referred to as “sub-band frequency division duplex (SBFDD)” or “flexible duplex.” In SBFD at a network node side, a first user equipment (UE) may transmit an uplink communication to a network node using an uplink sub-band of an SBFD set of symbols and a second UE may receive a downlink communication from the network node using a downlink sub-band of the SBFD set of symbols. In some examples, frequency resources used for downlink communication (e.g., the downlink sub-band of the SBFD set of symbols) may be separated from frequency resources used for uplink communication (e.g., the uplink sub-band of the SBFD set of symbols), in the frequency domain, by a guard band.

### SUMMARY

The systems, methods, and devices of this disclosure each have several innovative aspects, no single one of which is solely responsible for the desirable attributes disclosed herein.

Some aspects described herein relate to a method of wireless communication performed by a user equipment (UE). The method may include receiving configuration information indicating a first duplex pattern associated with a network node, where the first duplex pattern is associated with a format capable of being configured as one or more of time division duplex (TDD) patterns or sub-band full duplex (SBFD) patterns, and where the configuration information indicates, as the first duplex pattern, at least one of a first selected TDD pattern associated with the network node or a first selected SBFD pattern associated with the network node. The method may include communicating with the network node based at least in part on the configuration information.

Some aspects described herein relate to a method of wireless communication performed by a network node. The method may include transmitting, to a UE, configuration information indicating a first duplex pattern associated with the network node, where the first duplex pattern is associated with a format capable of being configured as one or more of TDD patterns or SBFD patterns, and where the configuration information indicates, as the first duplex pattern, at least one of a first selected TDD pattern associated with the network node or a first selected SBFD pattern associated with the network node. The method may include communicating with the UE based at least in part on the configuration information.

Some aspects described herein relate to a UE. The UE may include a processing system. The processing system may include one or more processors and one or more code-storing memories coupled with the one or more processors. The processing system may be configured to cause the UE to receive configuration information indicating a first duplex pattern associated with a network node, where the first duplex pattern is associated with a format capable of being configured as one or more of TDD patterns or SBFD patterns, and where the configuration information indicates, as the first duplex pattern, at least one of a first selected TDD pattern associated with the network node or a first selected SBFD pattern associated with the network node. The processing system may be configured to cause the UE to communicate with the network node based at least in part on the configuration information.

Some aspects described herein relate to a network node. The network node may include a processing system. The processing system may include one or more processors and one or more code-storing memories coupled with the one or more processors. The processing system may be configured to cause the network node to transmit, to a UE, configuration information indicating a first duplex pattern associated with the network node, where the first duplex pattern is associated with a format capable of being configured as one or more of TDD patterns or SBFD patterns, and where the configuration information indicates, as the first duplex pattern, at least one of a first selected TDD pattern associated with the network node or a first selected SBFD pattern associated with the network node. The processing system may be configured to cause the network node to communicate with the UE based at least in part on the configuration information.

Some aspects described herein relate to a non-transitory computer-readable medium that stores a set of instructions for wireless communication by a UE. The set of instructions, when executed by one or more processors of the UE, may cause the UE to receive configuration information indicating a first duplex pattern associated with a network node, where the first duplex pattern is associated with a format capable of being configured as one or more of TDD patterns or SBFD patterns, and where the configuration information indicates, as the first duplex pattern, at least one of a first selected TDD pattern associated with the network node or a first selected SBFD pattern associated with the network node. The set of instructions, when executed by one or more processors of the UE, may cause the UE to communicate with the network node based at least in part on the configuration information.

Some aspects described herein relate to a non-transitory computer-readable medium that stores a set of instructions for wireless communication by a network node. The set of instructions, when executed by one or more processors of the network node, may cause the network node to transmit, to a UE, configuration information indicating a first duplex pattern associated with the network node, where the first duplex pattern is associated with a format capable of being configured as one or more of TDD patterns or SBFD patterns, and where the configuration information indicates, as the first duplex pattern, at least one of a first selected TDD pattern associated with the network node or a first selected SBFD pattern associated with the network node. The set of instructions, when executed by one or more processors of the network node, may cause the network node to communicate with the UE based at least in part on the configuration information.

Some aspects described herein relate to an apparatus for wireless communication. The apparatus may include means for receiving configuration information indicating a first duplex pattern associated with a network node, where the first duplex pattern is associated with a format capable of being configured as one or more of TDD patterns or SBFD patterns, and where the configuration information indicates, as the first duplex pattern, at least one of a first selected TDD pattern associated with the network node or a first selected SBFD pattern associated with the network node. The apparatus may include means for communicating with the network node based at least in part on the configuration information.

Some aspects described herein relate to an apparatus for wireless communication. The apparatus may include means for transmitting, to a UE, configuration information indicating a first duplex pattern associated with the apparatus, where the first duplex pattern is associated with a format capable of being configured as one or more of TDD patterns or SBFD patterns, and where the configuration information indicates, as the first duplex pattern, at least one of a first selected TDD pattern or a first selected SBFD pattern. The apparatus may include means for communicating with the UE based at least in part on the configuration information.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communication network.

FIG. 2 is a diagram illustrating an example disaggregated network node architecture.

FIGS. 3A-3C are diagrams illustrating examples of full duplex communication.

FIG. 4 is a diagram illustrating examples of full-duplex communication in a wireless network.

FIG. 5 is a diagram illustrating an example of sub-band full duplex (SBFD) activation.

FIGS. 6A-6C are diagrams of examples associated with duplex pattern configurations for time division duplex patterns and SBFD patterns.

FIG. 7 is a diagram illustrating an example process performed, for example, at a user equipment (UE) or an apparatus of a UE.

FIG. 8 is a diagram illustrating an example process performed, for example, at a network node or an apparatus of a network node.

FIG. 9 is a diagram of an example apparatus for wireless communication.

FIG. 10 is a diagram of another example apparatus for wireless communication.

### DETAILED DESCRIPTION

In some examples, wireless communication may be associated with sub-band full duplex (SBFD) operation, which implies simultaneous transmission and reception of downlink communications and uplink communications on a sub-band basis at a network node. In SBFD symbols, a network node may dynamically configure an SBFD-aware user equipment (UE) to transmit in the uplink sub-band of an SBFD set of symbols while other UEs simultaneously receive downlink communications in one or more downlink sub-bands of the SBFD set of symbols, among other examples.

In such examples, the network node may configure the UE with multiple slot format pattern configurations, such as a time division duplex (TDD) pattern configuration associated with a half-duplex mode and an SBFD pattern configuration associated with a full-duplex mode. In such aspects, the wireless communication devices may be capable of switching between half-duplex and full-duplex operation. For example, the network node may instruct the UE to switch from the first configuration to a second configuration, or the UE may indicate to the network node that the UE is switching from the first configuration to the second configuration. By switching from the first configuration to the second configuration, the network node and the UE may experience increased quality or reliability of communications. For example, the network node and the UE may experience increased throughput (e.g., using a full-duplex mode), reduced latency (e.g., the UE may be able to transmit an uplink or a downlink communication sooner using the second configuration rather than the first configuration), and increased network resource utilization (e.g., by using both a downlink bandwidth part (BWP) and uplink BWP of SBFD sets of symbols simultaneously).

In some examples, providing the multiple configurations (e.g., the first configuration associated with the TDD pattern and the second configuration associated with the SBFD pattern) to multiple types of UEs may result in high overhead in a wireless communication network. That is, a network node may need to separately signal a cell-common TDD pattern configuration for non-SBFD-aware UEs and a cell-common SBFD configuration for SBFD-aware UEs. Additionally, or alternatively, in some examples, the configuration scheme described above may be relatively inflexible, because use of a slot format indicator (SFI) to dynamically switch between slot types may be restricted to flexible symbols (e.g., an SFI may be used to dynamically indicate that flexible symbols should be used as uplink symbols, downlink symbols, or remain flexible symbols). Notably, UEs (e.g., SBFD-aware UEs) may not expect to receive an SFI associated with other types of symbols, such as SBFD symbols, among other examples.

Various aspects relate generally to improved slot formats or patterns for SBFD operation. Some aspects more specifically relate to enabling a single format or pattern that can be used to indicate semi-static SBFD operation or semi-static TDD operation. In some aspects, a network node may transmit, and a UE may receive, configuration information indicating a duplex pattern associated with the network node. The duplex pattern may be associated with a format capable of being configured as one or more of TDD patterns or SBFD patterns, and thus the configuration information may indicate, as the duplex pattern, at least one of a selected TDD pattern or a selected SBFD pattern. The UE and the network node may thus communicate based at least in part on the configuration information. Some other techniques and aspects described herein enable dynamic switching between TDD patterns and SBFD patterns. In some aspects, the network node may transmit, and the UE may receive, a downlink control information (DCI) message indicating one or more duplex format indicators (DFIs). Each DFI may indicate that flexible symbols in a respective slot of the duplex pattern are to be converted to one of downlink symbols, SBFD symbols, or uplink symbols, or else that the flexible symbols in the respective slot of the duplex pattern are to remain flexible symbols and thus be used as guard symbols, among other examples.

Particular aspects of the subject matter described in this disclosure can be implemented to realize one or more of the following potential advantages. In some examples, using a single format or pattern to indicate semi-static SBFD operation or semi-static TDD operation may be associated with reduced overhead as compared to wireless communication systems in which a network node needs to separately signal a cell-common TDD pattern configuration for non-SBFD-aware UEs and a cell-common SBFD configuration for SBFD-aware UEs. Additionally, or alternatively, enabling dynamic switching between TDD patterns and SBFD patterns results in more flexible SBFD operation, thus resulting in reduced latency, increased throughput, and otherwise more efficient usage of network resources.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, SBFD), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

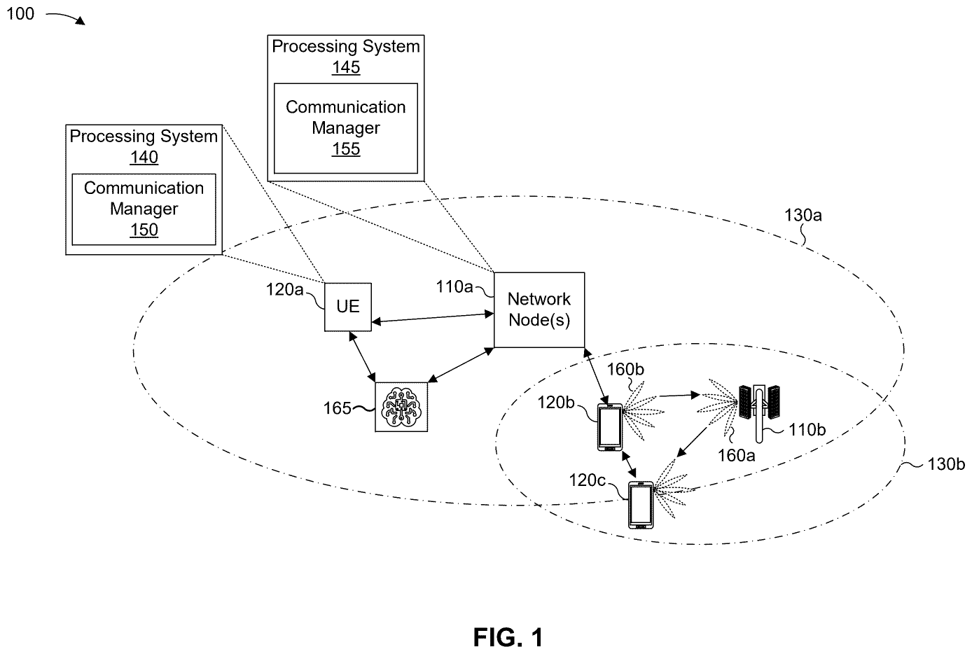

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, and as also shown, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into BWPs. A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a DCI configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, SFIs, preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples).

A network node 110 or a UE 120 operating in a half-duplex mode may perform only one of transmission or reception during particular time resources, such as during particular slots, symbols, or other time periods. In various examples, some of the network nodes 110 and the UEs 120 of the wireless communication network 100 may be configured for full-duplex operation in addition to half-duplex operation. In full-duplex operation, a network node 110 or a UE 120 operating in a full-duplex (for example, SBFD) mode can transmit and receive communications concurrently (for example, in the same time resources). For example, as shown in FIG. 1, the network node 110b may operate in the full-duplex mode. The network node 110b may concurrently receive uplink communications from the UE 120b and transmit downlink communications to the UE 120c. By operating in a full-duplex mode, network nodes 110 or UEs 120 may generally increase the capacity of the network and the radio access link. In some examples, full-duplex operation may involve frequency division duplex (FDD), in which downlink transmissions of the network node 110b are performed in a first frequency band or on a first component carrier and transmissions of the UE 120b are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an uplink transmission to a first network node 110 and receive a downlink transmission from a second network node 110 in the same time resources. In some other examples, full-duplex operation may be enabled for a network node 110 but not for a UE 120. For example, the network node 110b may simultaneously transmit a downlink transmission to a first UE 120 (for example, the UE 120c) and receive an uplink transmission from a second UE 120 (for example, the UE 120b) in the same time resources. In some other examples, full-duplex operation may be enabled for both a network node 110 and a UE 120.

In some aspects, the UE 120 may include a communication manager 150. As described in more detail elsewhere herein, the communication manager 150 may receive configuration information indicating a first duplex pattern associated with a network node, wherein the first duplex pattern is associated with a format capable of being configured as one or more of TDD patterns or SBFD patterns, and wherein the configuration information indicates, as the first duplex pattern, at least one of a first selected TDD pattern associated with the network node or a first selected SBFD pattern associated with the network node; and communicate with the network node based at least in part on the configuration information. Additionally, or alternatively, the communication manager 150 may perform one or more other operations described herein.

In some aspects, the network node 110 may include a communication manager 155. As described in more detail elsewhere herein, the communication manager 155 may transmit, to a UE, configuration information indicating a first duplex pattern associated with the network node, wherein the first duplex pattern is associated with a format capable of being configured as one or more of TDD patterns or SBFD patterns, and wherein the configuration information indicates, as the first duplex pattern, at least one of a first selected TDD pattern associated with the network node or a first selected SBFD pattern associated with the network node; and communicate with the UE based at least in part on the configuration information. Additionally, or alternatively, the communication manager 155 may perform one or more other operations described herein.

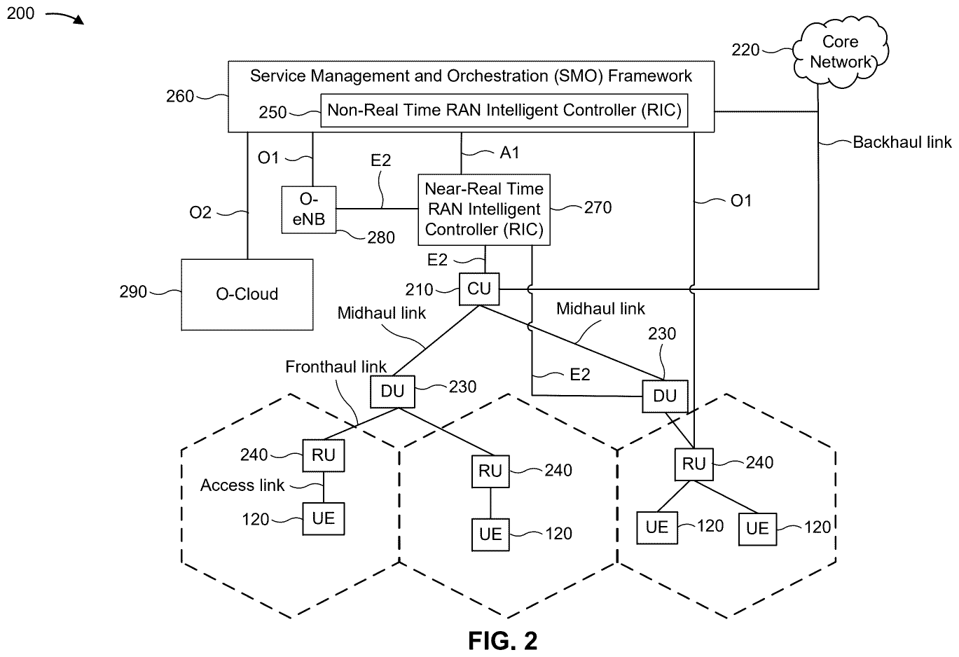

FIG. 2 is a diagram illustrating an example disaggregated network node architecture 200. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for transmitting or receiving signals, such as data, control information, or reference signals via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, or a Near-RT RIC 270. In some aspects, the SMO Framework 260 may communicate with a hardware aspect of a 4G RAN, a 5G NR RAN, or a 6G RAN, such as an open eNB (O-eNB) 280, via an O1 interface. Additionally, or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, or policy-based guidance of applications or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

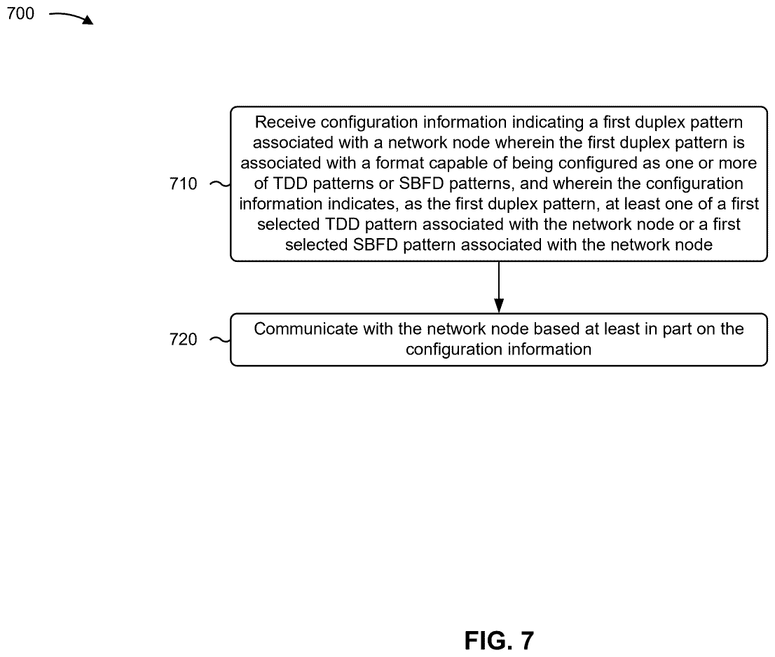

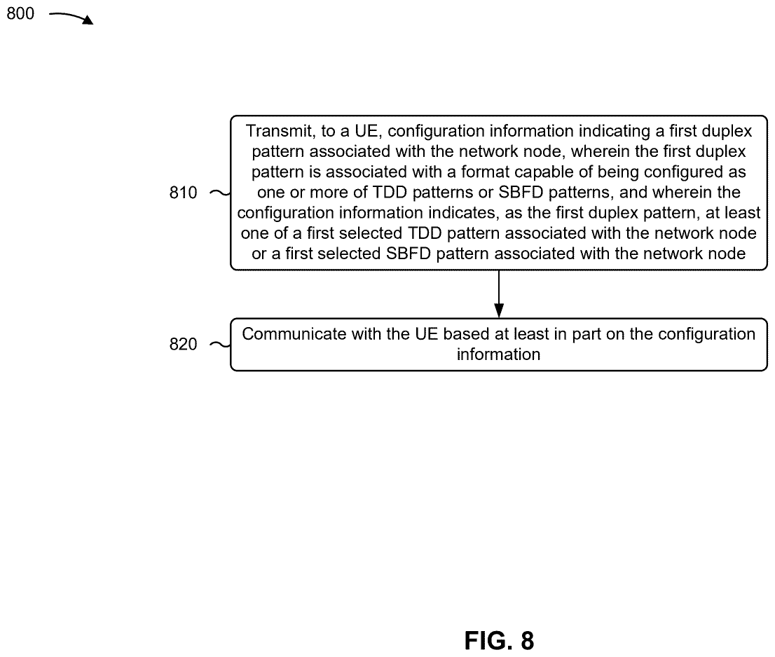

The network node 110, the processing system 145 of the network node 110, the UE 120, the processing system 140 of the UE 120, the CU 210, the DU 230, the RU 240, or any other component(s) of FIG. 1 or FIG. 2 may implement one or more techniques or perform one or more operations associated with duplex pattern configurations for TDD patterns and SBFD patterns, as described in more detail elsewhere herein. For example, the processing system 145 of the network node 110, the processing system 140 of the UE 120, the CU 210, the DU 230, or the RU 240 may perform or direct operations of, for example, process 700 of FIG. 7, process 800 of FIG. 8, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 700 of FIG. 7, process 800 of FIG. 8, or other processes as described herein. In some examples, executing instructions may include running the instructions, converting the instructions, compiling the instructions, or interpreting the instructions, among other examples.

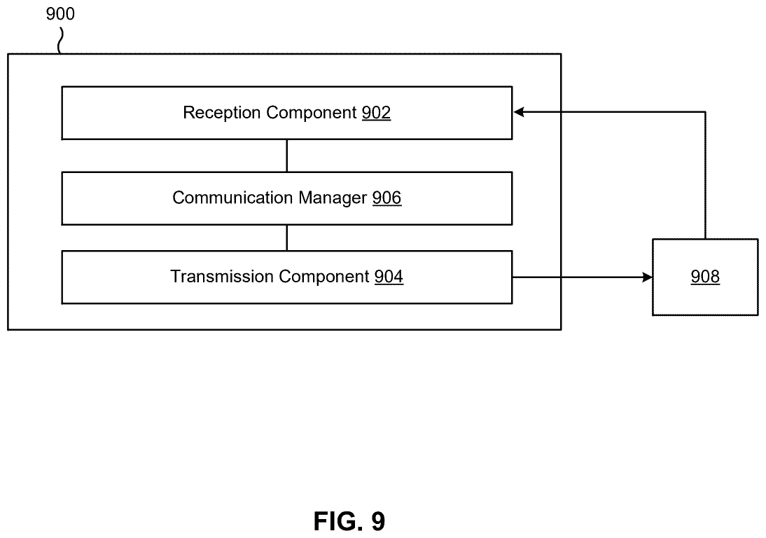

In some aspects, the UE 120 includes means for receiving configuration information indicating a first duplex pattern associated with a network node, wherein the first duplex pattern is associated with a format capable of being configured as one or more of TDD patterns or SBFD patterns, and wherein the configuration information indicates, as the first duplex pattern, at least one of a first selected TDD pattern associated with the network node or a first selected SBFD pattern associated with the network node; or means for communicating with the network node based at least in part on the configuration information. The means for the UE 120 to perform operations described herein may include, for example, one or more of communication manager 150, processing system 140, a radio, one or more RF chains, one or more transceivers, one or more antennas, one or more modems, a reception component (for example, reception component 902 depicted and described in connection with FIG. 9), or a transmission component (for example, transmission component 904 depicted and described in connection with FIG. 9), among other examples.

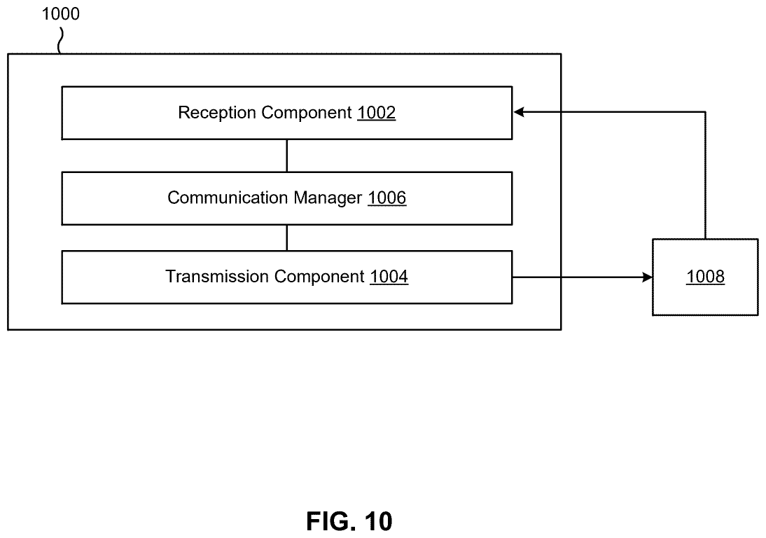

In some aspects, the network node 110 includes means for transmitting, to a UE, configuration information indicating a first duplex pattern associated with the network node 110, wherein the first duplex pattern is associated with a format capable of being configured as one or more of TDD patterns or SBFD patterns, and wherein the configuration information indicates, as the first duplex pattern, at least one of a first selected TDD pattern associated with the network node 110 or a first selected SBFD pattern associated with the network node 110; or means for communicating with the UE based at least in part on the configuration information. The means for the network node 110 to perform operations described herein may include, for example, one or more of communication manager 155, processing system 145, a radio, one or more RF chains, one or more transceivers, one or more antennas, one or more modems, a reception component (for example, reception component 1002 depicted and described in connection with FIG. 10), or a transmission component (for example, transmission component 1004 depicted and described in connection with FIG. 10), among other examples.

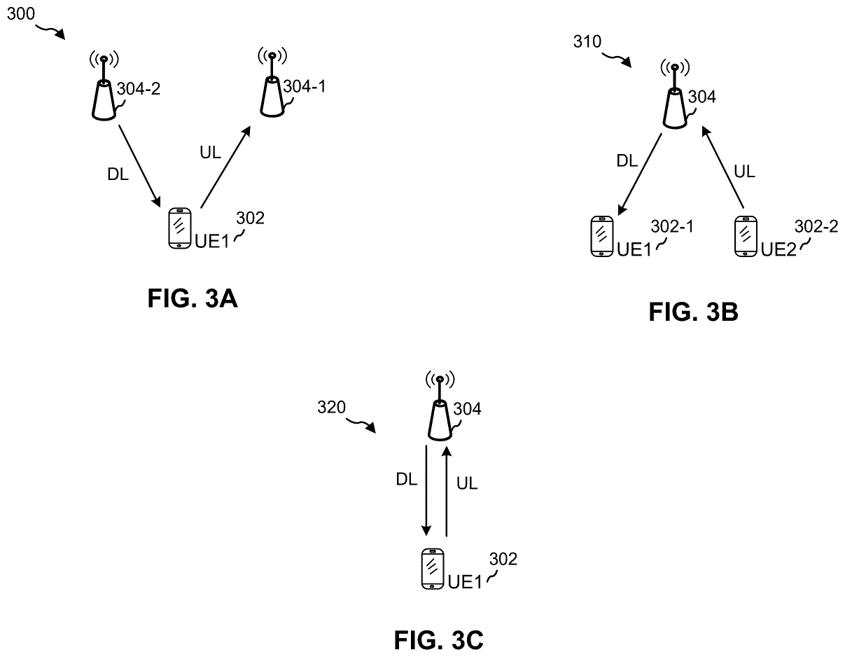

FIGS. 3A-3C are diagrams illustrating examples 300, 310, 320 of full duplex (FD) communication. “Full-duplex communication” in a wireless network refers to simultaneous bi-directional communication between devices in the wireless network. For example, a UE operating in a full-duplex mode may transmit an uplink communication and receive a downlink communication at the same time (e.g., in the same slot or the same symbol). “Half-duplex communication” in a wireless network refers to unidirectional communications (e.g., only downlink communication or only uplink communication) between devices at a given time (e.g., in a given slot or a given symbol).

The example 300 of FIG. 3A includes a UE1 302 and two network nodes (e.g., TRPs) 304-1, 304-2, where the UE1 302 is sending UL transmissions to network node 304-1 and is receiving DL transmissions from network node 304-2. In the example 300 of FIG. 3A, FD is enabled for the UE1 302, but not for the network nodes 304-1, 304-2. The example 310 of FIG. 3B includes two UEs, shown as UE1 302-1 and UE2 302-2, and a network node 304, where the UE1 302-1 is receiving a DL transmission from the network node 304 and the UE2 302-2 is transmitting an UL transmission to the network node 304. In the example 310 of FIG. 3B, FD is enabled for the network node 304, but not for UE1 302-1 and UE2 302-2. The example 320 of FIG. 3C includes a UE1 302 and a network node 304, where the UE1 302 is receiving a DL transmission from the network node 304 and the UE1 302 is transmitting an UL transmission to the network node 304. In the example 320 of FIG. 3C, FD is enabled for both the UE1 302 and the network node 304.

As indicated above, FIGS. 3A-3C are provided as one or more examples. Other examples may differ from what is described with regard to FIGS. 3A-3C.

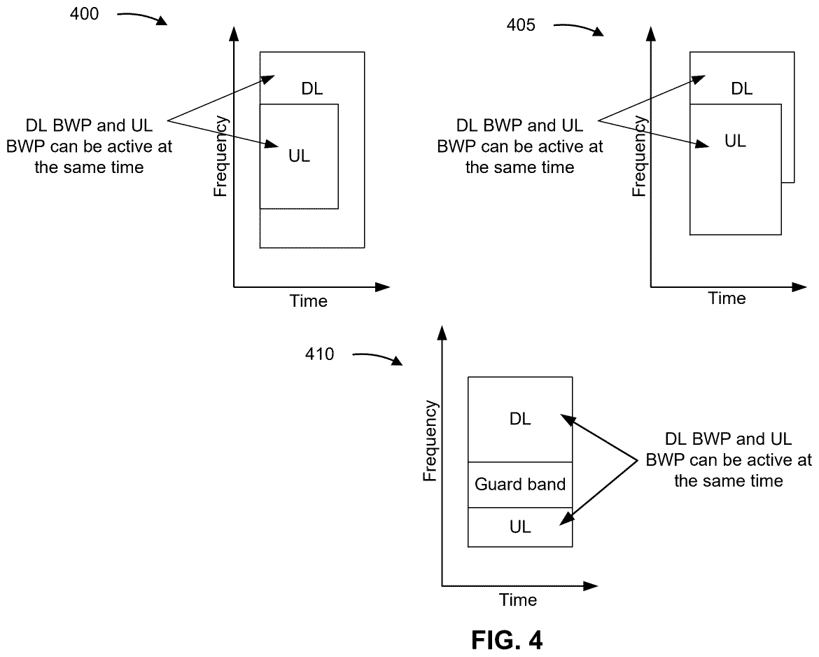

FIG. 4 is a diagram illustrating examples 400, 405, and 410 of full-duplex communication in a wireless network. As shown in FIG. 4, examples 400 and 405 show examples of in-band full-duplex (IBFD) communication. In IBFD, a UE may transmit an uplink communication to a network node and receive a downlink communication from the network node on the same time and frequency resources. As shown in example 400, in a first example of IBFD, the time and frequency resources for uplink communication may fully overlap with the time and frequency resources for downlink communication. As shown in example 405, in a second example of IBFD, the time and frequency resources for uplink communication may partially overlap with the time and frequency resources for downlink communication.

As further shown in FIG. 4, example 410 shows an example of SBFD communication, which may also be referred to as “sub-band frequency division duplex (SBFDD)” or “flexible duplex.” In SBFD, a UE may transmit an uplink communication to a network node and receive a downlink communication from the network node at the same time, but on different frequency resources. For example, the different frequency resources may be sub-bands of a frequency band, such as a time division duplexing band. In this case, the frequency resources used for downlink communication may be separated from the frequency resources used for uplink communication, in the frequency domain, by a guard band.

As indicated above, FIG. 4 is provided as an example. Other examples may differ from what is described with respect to FIG. 4.

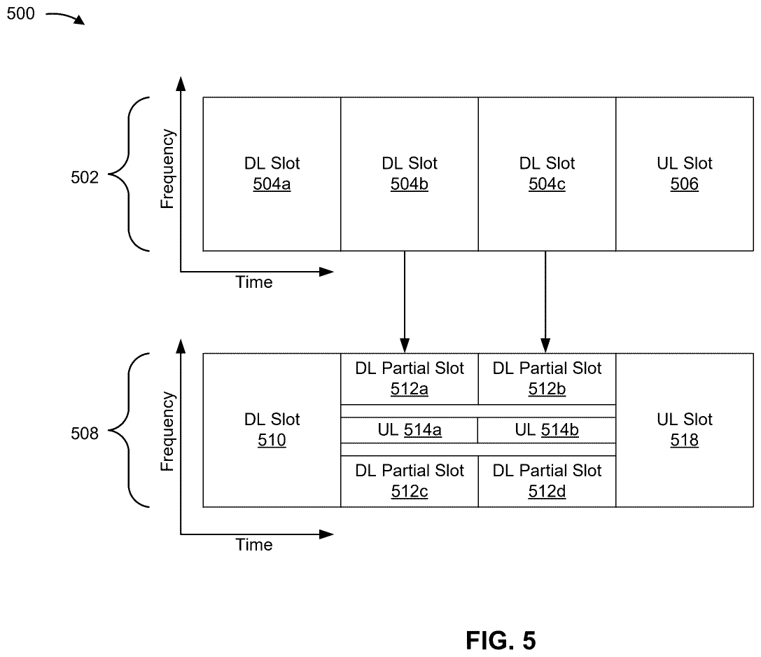

FIG. 5 is a diagram illustrating an example 500 of SBFD activation. As shown in FIG. 5, example 500 includes a first configuration 502. In some aspects, the first configuration 502 may indicate a first slot format pattern (sometimes called a TDD pattern) associated with a half-duplex mode or a full-duplex mode. The first slot format pattern may include a quantity of downlink slots (e.g., three downlink slots 504a, 504b, and 504c, as shown), a quantity of flexible slots (not shown), or a quantity of uplink slots (e.g., one uplink slot 506, as shown). The first slot format pattern may repeat over time. In some aspects, a network node 110 may indicate the first slot format pattern to a UE 120 using one or more SFIs. A slot format indicator, for a slot, may indicate whether that slot is an uplink slot, a downlink slot, or a flexible slot, among other examples.

A network node 110 may instruct (e.g., using an indication, such as an RRC message, a MAC-CE, or DCI) a UE 120 to switch from the first configuration 502 to a second configuration 508. As an alternative, the UE 120 may indicate to the network node 110 that the UE 120 is switching from the first configuration 502 to the second configuration 508. The second configuration 508 may indicate a second slot format pattern (sometimes called an SBFD pattern) that repeats over time, similar to the first slot format pattern. In any of the aspects described above, the UE 120 may switch from the first configuration 502 to the second configuration 508 during a time period (e.g., a quantity of symbols or an amount of time (e.g., in ms)) based at least in part on an indication received from the network node 110 (e.g., before switching back to the first configuration 502). During that time period, the UE 120 may communicate using the second slot format pattern, and then may revert to using the first slot format pattern after the end of the time period. The time period may be indicated by the network node 110 (e.g., in the instruction to switch from the first configuration 502 to the second configuration 508, as described above) or based at least in part on a programmed or otherwise preconfigured rule. For example, the rule may be based at least in part on a table (e.g., defined in 3GPP specifications or another wireless communication standard) that associates different SCSs or numerologies (e.g., represented by μ and associated with corresponding SCSs) with corresponding time periods for switching configurations.

In example 500, the second slot format pattern includes a downlink slot 510 (in place of downlink slot 504a), an uplink slot 518 (in place of uplink slot 506), and two SBFD slots in place of what were downlink slots in the first slot format pattern (in place of downlink slots 504 b and 504 c). In example 500, each SBFD slot includes a partial slot (e.g., a portion or sub-band of a frequency allocated for use by the network node 110 and the UE 120) for downlink (e.g., partial slots 512a, 512b, 512c, and 512d, as shown) and a partial slot for uplink (e.g., partial slots 514a and 514b, as shown). Accordingly, the UE 120 may operate using the second slot format pattern to transmit an uplink communication in an earlier slot (e.g., the second slot in sequence, shown as partial UL slot 514a) as compared to using the first slot format pattern (e.g., the fourth slot in sequence, shown as UL slot 506). Other examples may include additional or alternative changes. For example, the second configuration 508 may indicate an SBFD slot in place of what was an uplink slot in the first configuration 502 (e.g., UL slot 506). In another example, the second configuration 508 may indicate a downlink slot or an uplink slot in place of what was an SBFD slot in the first configuration 502 (not shown in FIG. 5). In yet another example, the second configuration 508 may indicate a downlink slot or an uplink slot in place of what was an uplink slot or a downlink slot, respectively, in the first configuration 502. An “SBFD slot” may refer to a slot in which an SBFD format is used. An SBFD format may include a slot format in which full duplex communication is supported (e.g., for both uplink and downlink communications), with one or more frequencies used for an uplink portion of the slot being separated from one or more frequencies used for a downlink portion of the slot by a guard band. In some aspects, the SBFD format may include a single uplink portion and a single downlink portion separated by a guard band. In some aspects, the SBFD format may include multiple downlink portions and a single uplink portion that is separated from the multiple downlink portions by respective guard bands (e.g., as shown in FIG. 5). In some aspects, an SBFD format may include multiple uplink portions and a single downlink portion that is separated from the multiple uplink portions by respective guard bands. In some aspects, the SBFD format may include multiple uplink portions and multiple downlink portions, where each uplink portion is separated from a downlink portion by a guard band. In some aspects, operating using an SBFD mode may include activating or using an FD mode in one or more slots based at least in part on the one or more slots having the SBFD format. A slot may support the SBFD mode if an UL BWP and a DL BWP are permitted to be or are simultaneously active in the slot in an SBFD fashion (e.g., with guard band separation).

By switching from the first configuration 502 to the second configuration 508, the network node 110 and the UE 120 may experience increased quality or reliability of communications. For example, the network node 110 and the UE 120 may experience increased throughput (e.g., using a full-duplex mode), reduced latency (e.g., the UE 120 may be able to transmit an uplink or a downlink communication sooner using the second configuration 508 rather than the first configuration 502), and increased network resource utilization (e.g., by using both the DL BWP and the UL BWP simultaneously instead of only the DL BWP or the UL BWP).

In some examples, SBFD symbols may only be configured in symbols that are semi-statically configured as downlink or flexible symbols (e.g., in a TDD-uplink-downlink common configuration, sometimes referred to as TDD-UL-DL-ConfigCommon). SBFD symbols may start from any symbol within a slot and may end in any symbol within a slot. In this regard, a certain slot may include SBFD symbols and non-SBFD symbols. In some examples, SBFD symbols may be configured in a consecutive manner within each TDD pattern period. Moreover, when only one TDD pattern is configured, SBFD symbols may be configured in a consecutive manner within a TDD pattern period. When two TDD patterns are configured, SBFD symbols may be configured for only one of the TDD patterns or may be configured for both of the TDD patterns. Additionally, or alternatively, when only one TDD pattern is configured, an SBFD sub-band time period may be the same as the TDD pattern period configured by the network node 110 (e.g., via a DL-UL-TransmissionPeriodicity information element (IE) as part of TDD-UL-DL-ConfigCommon). When two TDD patterns are configured, the SBFD sub-band time period may be the same as the sum of the two TDD pattern periods configured by the network node 110 (e.g., via respective DL-UL-TransmissionPeriodicity IEs as part of TDD-UL-DL-ConfigCommon). Additionally, or alternatively, an SCS indicated by a ReferenceSubcarrierSpacing IE in TDD-UL-DL-ConfigCommon may be used as a reference SCS for the SBFD pattern configuration.

In some examples, providing the multiple configurations (e.g., the first configuration associated with the TDD pattern and the second configuration associated with the SBFD pattern) to multiple types of UEs may result in high overhead in a wireless communication network. That is, a network node 110 may need to separately signal a cell-common TDD pattern configuration (e.g., for use by non-SBFD-aware UEs in the cell) and a cell-common SBFD configuration (e.g., for use by SBFD-aware UEs in the cell). Additionally, or alternatively, the configuration scheme described above may be relatively inflexible, because use of the SFI described above may be restricted to flexible symbols (e.g., SFI may be used to dynamically indicate that flexible symbols should be used as uplink symbols, downlink symbols, or remain flexible symbols). Notably, UEs (e.g., SBFD-aware UEs) may not expect to receive an SFI associated with other types of symbols, such as SBFD symbols, among other examples.

Some techniques and aspects described herein enable a single format or pattern that can be used to indicate semi-static SBFD operation or semi-static TDD operation. More particularly, in some aspects, a network node may transmit, and UE may receive, configuration information indicating a duplex pattern associated with the network node, with the first duplex pattern being associated with a format capable of being configured as one or more of TDD patterns or SBFD patterns. In this regard, the configuration information may indicate, as the first duplex pattern, at least one of a first selected TDD pattern associated with the network node or a first selected SBFD pattern associated with the network node. Accordingly, the network node and the UE may communicate based at least in part on the configured duplex pattern.

Some other techniques and aspects described herein enable dynamic switching between TDD patterns and SBFD patterns. More particularly, the configured duplex pattern may include a downlink set of symbols, a first flexible set of symbols that is capable of being converted to downlink symbols or SBFD symbols, an SBFD set of symbols, a second flexible set of symbols that is capable of being converted to SBFD symbols or uplink symbols, or an uplink set of symbols. In such aspects, the network node may transmit, and the UE may receive, a DCI message indicating one or more DFIs. Each DFI may indicate that flexible symbols in a respective slot of the configured duplex pattern are to be converted to one of downlink symbols, SBFD symbols, or uplink symbols, or else are to remain flexible symbols (e.g., to be used as guard symbols, among other examples).

As a result, using a single format or pattern to indicate semi-static SBFD operation or semi-static TDD operation may be associated with reduced overhead as compared to wireless communication systems in which a network node needs to separately signal a cell-common TDD pattern configuration for non-SBFD-aware UEs in the cell and a cell-common SBFD configuration for SBFD-aware UEs in the cell. Additionally, or alternatively, enabling dynamic switching between TDD patterns and SBFD patterns may result in more flexible SBFD operation when channel conditions permit, thus resulting in reduced latency, increased throughput, and otherwise more efficient usage of network resources.

As indicated above, FIG. 5 is provided as an example. Other examples may differ from what is described with respect to FIG. 5.

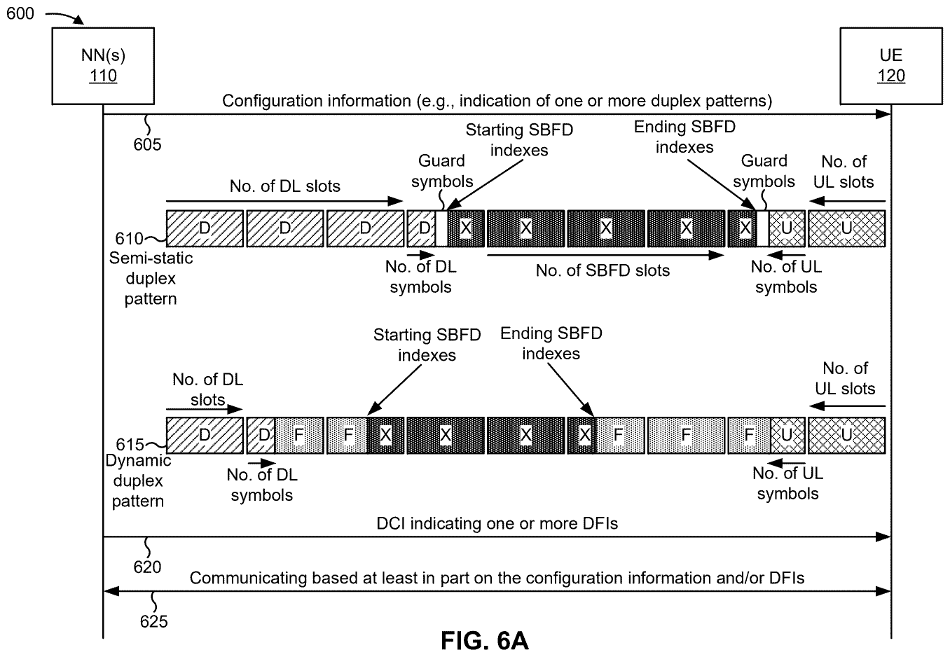

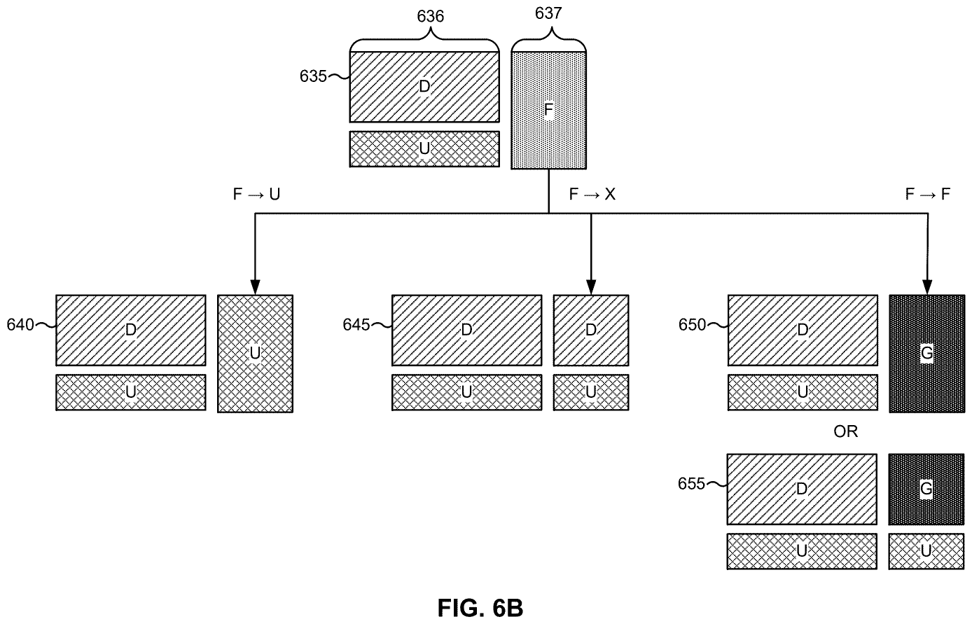

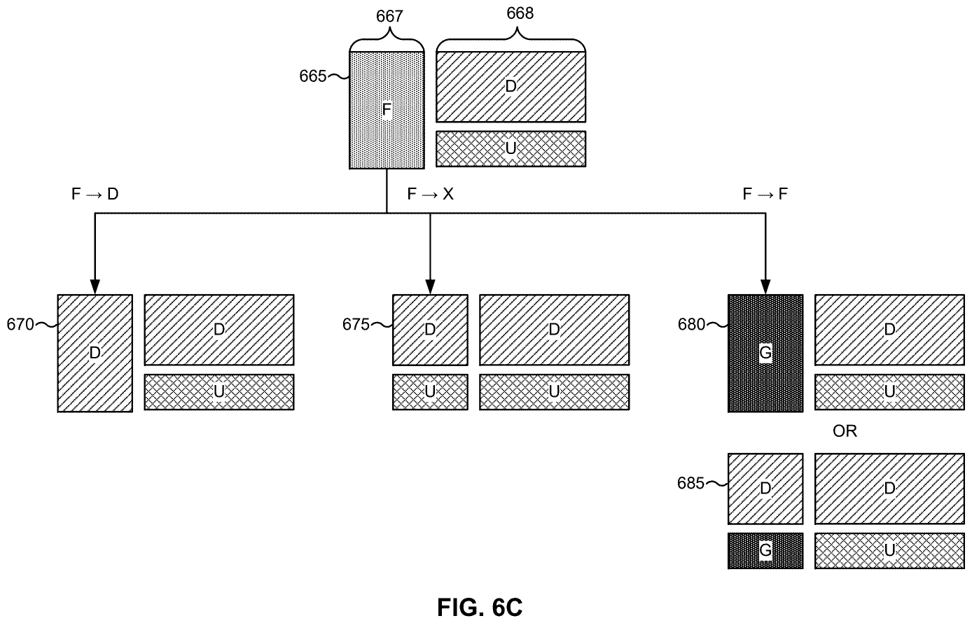

FIGS. 6A-6C are diagrams of examples associated with duplex pattern configurations for TDD patterns and SBFD patterns. As shown in FIG. 6A, and by example 600, a network node 110 (e.g., a base station, a CU, a DU, or an RU) may communicate with a UE 120. In some aspects, the network node 110 and the UE 120 may be part of a wireless network (e.g., the wireless communication network 100). The UE 120 and the network node 110 may have established a wireless connection prior to operations shown in FIG. 6A. In some aspects, the network node 110 or the UE 120 may be capable of FD communications. For example, the network node 110 may be capable of SBFD operation, and the UE 120 may be an SBFD-aware UE.

As shown by reference number 605, the network node 110 may transmit, and the UE 120 may receive, configuration information. In some aspects, the UE 120 may receive the configuration information via one or more of system information signaling (e.g., a master information block (MIB) or a system information block (SIB), among other examples), RRC signaling, MAC signaling (e.g., one or more MAC-CEs), or physical layer signaling (e.g., DCI), among other examples. For example, as described in more detail below, in some aspects the configuration information may indicate a semi-static duplex pattern associated with wireless communications between the network node 110 and the UE 120. In such aspects, the semi-static duplex pattern may be signaled via at least one of a SIB1 or a cell-specific dedicated configuration (e.g., a configuration associated with secondary cell (SCell) addition of neighboring cell handover or mobility, among other examples). Additionally, or alternatively, although not shown in FIG. 6A, in some aspects the network node 110 may signal the semi-static duplex pattern to other network nodes (e.g., neighboring cells). For example, the network node 110 may signal a cell-specific duplex pattern to one or more neighboring cell via an Xn application protocol (XnAP) or an F1 application protocol (F1AP) interface to enable proper inter-cell cross-link interference (CLI) mitigation or slot-pattern alignment, among other examples.

In some aspects, the configuration information may indicate one or more candidate configurations or communication parameters. In some aspects, the one or more candidate configurations or communication parameters may be selected, activated, or deactivated by a subsequent indication. For example, the subsequent indication may select a candidate configuration or communication parameter from the one or more candidate configurations or communication parameters. In some aspects, the subsequent indication may include a dynamic indication, such as one or more MAC-CEs or one or more DCI messages, among other examples.

In some aspects, the configuration information may include an indication of a selection of one or more configuration parameters (e.g., a selection of the one or more configuration parameters already known to the UE 120 or previously indicated by the network node or other network device), or explicit configuration information for the UE 120 to use to configure the UE 120, among other examples.

In some examples, the configuration information may not be expressly signaled to the UE 120. For example, in some aspects, the configuration information may at least partially be defined by a wireless communication standard, such as the 3GPP. In such examples, the network node 110 may not explicitly indicate such configuration information to the UE 120. For example, the UE 120 may optionally obtain at least a portion of the configuration information from a configuration stored by the UE 120 (e.g., an original equipment manufacturer (OEM) configuration). In some aspects, the configuration information may include a parameter or index that is indicative of information defined, or otherwise fixed, by a wireless communication standard, such as the 3GPP (e.g., rather than explicitly indicating the information).

In some aspects, the configuration information may indicate a duplex pattern associated with the network node 110, such as via a duplex pattern configuration parameter (sometimes referred to herein as XDD-UL-DL-Pattern). The duplex pattern may be associated with a format capable of being configured as one or more of TDD patterns or SBFD patterns. That is, a single format/pattern may be used by the network node to indicate at least one of a selected SBFD pattern (e.g., a pattern that includes downlink sets of symbols (sometimes referred to herein as “D” slots or symbols), uplink sets of symbols (sometimes referred to herein as “U” slots or symbols), or SBFD sets of symbols (sometimes referred to herein as “X” slots or symbols or flexible symbols (e.g., “F” slots or symbols) that are capable of being converted to X symbols, as described in more detail below), or a selected TDD pattern (e.g., a pattern that includes D sets of symbols, U sets of symbols, or special or switch sets of symbols (sometimes referred to herein as “S” slots or symbols)).

For example, when the network node 110 is operating in an SBFD mode, the selected duplex pattern may be associated with at least one SBFD slot, such as a pattern that begins with one of a downlink set of symbols or an SBFD set of symbols and ends with one of an uplink set of symbols or the SBFD set of symbols. That is, when the network node 110 is operating in an SBFD mode, the selected duplex pattern may be associated with one of XXXXX, XXXXU, or DXXXU, among other examples. In some examples, a duplex pattern of XXXXX (e.g., a pattern in which all slots are SBFD slots) may be used in scenarios to enable true FDD in green spectrum scenarios or green deployments, among other examples. Moreover, a duplex pattern of XXXXU may be used in scenarios in which SBFD operation is desirable but in which some symbols are used as only uplink symbols for channel reciprocity purposes (e.g., to transmit SRSs, among other examples). A duplex pattern of DXXXU may be used in scenarios in which SBFD operation is desirable but in which some symbols are used as only downlink symbols or uplink symbols to enable CLI-free downlink or uplink communications, respectively, among other examples. Moreover, when the network node 110 is not operating in an SBFD mode (e.g., when the network node 110 is operating in a TDD mode), the selected duplex pattern may be associated with no SBFD slots (e.g., no X slots), such as a pattern of DDDSU, among other examples.

Additionally, or alternatively, in some aspects, the configuration information may indicate multiple (e.g., two) selected duplex patterns that are to be used back-to-back (e.g., the network node 110 and the UE 120 may communicate using the first duplex pattern, followed the second duplex pattern, then followed by the first duplex pattern, and then the second duplex pattern, and so forth). Put another way, the configuration information may indicate a first duplex pattern (with the configuration information indicating, as the first duplex pattern, at least one of a first selected TDD pattern or a first selected SBFD pattern) as well a second duplex pattern (with the configuration information indicating, as the second duplex pattern, at least one of a second selected TDD pattern or a second selected SBFD pattern).

Moreover, in aspects in which the configuration information indicates multiple (e.g., two) duplex patterns, based at least in part on a pre-defined rule (e.g., a rule promulgated by the 3GPP, among other examples), both duplex patterns may be associated with a semi-static duplex pattern (e.g., a pattern including only D sets of symbols, U sets of symbols, or X sets of symbols, as described in more detail below in connection with the semi-static duplex pattern 610), or else both duplex patterns may be associated with a dynamic duplex pattern (e.g., a pattern including F sets of symbols capable of being converted to U sets of symbols, D sets of symbols, or X sets of symbols via a dynamic indication, as described in more detail below in connection with the dynamic duplex pattern 615). In some other aspects, based at least in part on a pre-defined rule (e.g., a rule promulgated by the 3GPP, among other examples), one of the duplex patterns may be associated with a semi-static duplex pattern and the other one of the duplex patterns may be associated with a dynamic duplex pattern.

Additionally, or alternatively, in aspects in which the configuration information indicates multiple (e.g., two) duplex patterns, based at least in part on a pre-defined rule (e.g., a rule promulgated by the 3GPP, among other examples), one of the duplex patterns may be associated with an SBFD pattern (e.g., a pattern including X sets of symbols or F sets of symbols capable of being converted to X sets of symbols) and the other duplex pattern may be associated with a TDD pattern (e.g., a pattern not including X sets of symbols or F sets of symbols that are capable of being converted to X sets of symbols), or else both duplex patterns may be associated with the same type of pattern (e.g., both may be associated with SBFD patterns or both may be associated with TDD patterns). In some other aspects, the duplex patterns may be independently selected or configured (e.g., a duplex pattern may be configured as a TDD pattern or SBFD pattern regardless of whether the other duplex pattern is configured as a TDD pattern or SBFD pattern). Put another way, in some aspects, the first duplex pattern may be associated with a selected TDD pattern or a selected SBFD pattern independently of whether the second duplex pattern is associated with a TDD pattern or an SBFD pattern, and, similarly, the second duplex pattern may be associated with a selected TDD pattern or a selected SBFD pattern independently of whether the first duplex pattern is associated with a TDD pattern or an SBFD pattern.

As described above, in some aspects a configured duplex pattern may be a semi-static duplex pattern. A semi-static duplex pattern is a pattern in which the symbols are configured as D symbols, X symbols, or U symbols (with no F symbols). For example, as shown by the example semi-static duplex pattern 610 in FIG. 6A, a semi-static duplex pattern may include D symbols at a beginning of the pattern, X symbols in a middle of the pattern, and U symbols at an end of the pattern. Alternatively, and as described above, in some aspects a semi-static duplex pattern may begin or end with SBFD symbols (e.g., a duplex pattern may omit the D symbols or the U symbols). Put another way, a semi-static duplex pattern (e.g., semi-static duplex pattern 610 or a similar pattern) may start with D or X symbols and may end with X or U symbols. In aspects in which the configured duplex pattern is a semi-static duplex pattern (e.g., semi-static duplex pattern 610), no F symbols may be necessary because the X symbols may enable flexibility of simultaneous uplink and downlink transmissions. Additionally, or alternatively, in some aspects a semi-static duplex pattern may include guard or transition symbols, such as the guard symbols shown in connection with the semi-static duplex pattern 610 (e.g., between the last of the D symbols and the first of the X symbols or between the last of the X symbols and the first of the U symbols), among other examples.

In some aspects, such as aspects associated with a semi-static duplex pattern (e.g., semi-static duplex pattern 610), the configuration information may indicate a selected TDD pattern or SBFD pattern by indicating one or more of a number of downlink slots parameter (sometimes referred to herein as nrofDownlinkSlots), a number of downlink symbols parameter (sometimes referred to herein as nrofDownlinkSymbols), a number of uplink slots parameter (sometimes referred to herein as nrofUplinkSlots), a number of uplink symbols parameter (sometimes referred to herein as nrofUplinkSymbols), a number of guard symbols parameter (sometimes referred to herein as nrofGuardSymbols), a starting SBFD slot parameter (sometimes referred to herein as starting_SBFD_slot), a starting SBFD symbol parameter (sometimes referred to herein as starting_SBFD_symbols), an ending SBFD slot parameter (sometimes referred to herein as ending_SBFD_slot), an ending SBFD symbol parameter (sometimes referred to herein as ending_SBFD_symbols), or a number of SBFD slots parameter (sometimes referred to herein as nrofSBFDSlots), among other examples. For example, the configuration information may indicate the selected TDD pattern or SBFD pattern by using an XDD-UL-DL-Pattern IE that includes one or more of nrofDownlinkSlots, nrofDownlinkSymbols, nrofUplinkSlots, nrofUplinkSymbols, nrofGuardSymbols, starting_SBFD_slot, starting_SBFD_symbols, ending_SBFD_slot, ending_SBFD_symbols, or nrofSBFDSlots, among other examples.

More particularly, in some aspects, the selected duplex pattern may be signaled by indicating the number of downlink slots parameter (e.g., nrofDownlinkSlots) that indicates a number of downlink slots at a beginning of the duplex pattern, the number of downlink symbols parameter (e.g., nrofDownlinkSymbols) that indicates a number of downlink symbols that follow the downlink slots, the number of uplink slots parameter (e.g., nrofUplinkSlots) that indicates a number of uplink slots at an end of the duplex pattern, and the number of uplink symbols parameter (e.g., nrofUplinkSymbols) that indicates a number of uplink symbols that precede the uplink slots. Moreover, if guard symbols are to be used, the configuration information may indicate the number of guard symbols parameter (e.g., nrofGuardSymbols) that indicates a first number of guard symbols that follow the downlink symbols or a second number of guard symbols that precede the uplink symbols. In such aspects, the remaining symbols in the duplex pattern may be implicitly configured as SBFD symbols (e.g., X symbols). Put another way, the UE 120 may infer which symbols are SBFD symbols based at least in part on a length of the duplex pattern (e.g., indicated by TransmissionPeriodicity), the number of downlink slots parameter (e.g., nrofDownlinkSlots, which may greater than or equal to zero), the number of downlink symbols parameter (e.g., nrofDownlinkSymbols, which may greater than or equal to zero), the number of uplink slots parameter (e.g., nrofUplinkSlots, which may be greater than or equal to zero), the number of uplink symbols parameter (e.g., nrofUplinkSymbols, which may be greater than or equal to zero), and, optionally, the number of guard symbols parameter (e.g., nrofGuardSymbols, which may be greater than or equal to zero).

In some other aspects, the selected duplex pattern may be signaled by indicating the starting SBFD slot parameter (e.g., starting_SBFD_slot) that indicates a first slot index associated with a starting SBFD slot, the starting SBFD symbol parameter (e.g., starting_SBFD_symbol) that indicates a first symbol index of a starting SBFD symbol associated with the starting SBFD slot, the ending SBFD slot parameter (e.g., ending_SBFD_slot) that indicates a slot index associated with an ending SBFD slot, and the ending SBFD symbol parameter (e.g., ending_SBFD_symbol) that indicates a second symbol index of an ending SBFD symbol associated with the ending SBFD slot. Moreover, if guard symbols are to be used, the configuration information may indicate the number of guard symbols parameter (e.g., nrofGuardSymbols) that indicates a number of guard symbols that precede the starting SBFD symbols or follow the ending SBFD symbols. In such aspects, the remaining symbols before the SBFD symbols and any guard symbols may be implicitly configured as downlink symbols (e.g., D symbols) and the remaining symbols after the SBFD symbols and any guard symbols maybe implicitly configured as uplink symbols (e.g., U symbols). Put another way, in such aspects the UE 120 may infer which symbols are downlink symbols or uplink symbols based at least in part on a length of the duplex pattern (e.g., indicated by TransmissionPeriodicity), the starting SBFD slot parameter (e.g., starting_SBFD_slot), the starting SBFD symbol parameter (e.g., starting_SBFD_symbol), the ending SBFD slot parameter (e.g., ending_SBFD_slot), the ending SBFD symbol parameter (e.g., ending_SBFD_symbol), and, optionally, the number of guard symbols parameter (e.g., nrofGuardSymbols).

In some other aspects, the selected duplex pattern may be signaled by indicating the number of downlink slots parameter (e.g., nrofDownlinkSlots), the number of downlink symbols parameter (e.g., nrofDownlinkSymbols), the starting SBFD symbol parameter (e.g., starting_SBFD_symbol), the number of SBFD slots parameter (e.g., nrofSBFDslots) that indicates a number of SBFD slots that follow the starting SBFD symbols, and the ending SBFD slot parameter (e.g., ending_SBFD_symbol). Moreover, if guard symbols are to be used, the configuration information may indicate the number of guard symbols parameter (e.g., nrofGuardSymbols) that indicates a number of guard symbols that follow the downlink symbols and precede the starting SBFD symbols or follow the ending SBFD symbols. In such aspects, the remaining symbols in the duplex pattern may be implicitly configured as uplink symbols (e.g., U symbols). Put another way, in such aspects the UE 120 may infer which symbols are uplink symbols based at least in part on a length of the duplex pattern (e.g., indicated by TransmissionPeriodicity), the number of downlink slots parameter (e.g., nrofDownlinkSlots), the number of downlink symbols parameter (e.g., nrofDownlinkSymbols), the starting SBFD symbol parameter (e.g., starting_SBFD_symbol), the number of SBFD slots parameter (e.g., nrofSBFDslots, which may be greater than or equal to zero), the ending SBFD slot parameter (e.g., ending_SBFD_symbol), and, optionally, the number of guard symbols parameter (e.g., nrofGuardSymbols).

In some other aspects, the selected duplex pattern may be signaled by indicating the number of uplink slots parameter (e.g., nrofUplinkSlots), the number of uplink symbols parameter (e.g., nrofUplinkSymbols), the starting SBFD symbol parameter (e.g., starting_SBFD_symbol), the number of SBFD slots parameter (e.g., nrofSBFDslots), and the ending SBFD slot parameter (e.g., ending_SBFD_symbol). Moreover, if guard symbols are to be used, the configuration information may indicate the number of guard symbols parameter (e.g., nrofGuardSymbols) that indicates a number of guard symbols that follow the ending SBFD symbols and precede the uplink symbols or precede the starting SBFD symbols. In such aspects, the remaining symbols in the duplex pattern may be implicitly configured as downlink symbols (e.g., D symbols). Put another way, in such aspects the UE 120 may infer which symbols are downlink symbols based at least in part on a length of the duplex pattern (e.g., indicated by TransmissionPeriodicity), the number of uplink slots parameter (e.g., nrofUplinkSlots), the number of uplink symbols parameter (e.g., nrofUplinkSymbols), the starting SBFD symbol parameter (e.g., starting_SBFD_symbol), the number of SBFD slots parameter (e.g., nrofSBFDslots), the ending SBFD slot parameter (e.g., ending_SBFD_symbols), and, optionally, the number of guard symbols parameter (e.g., nrofGuardSymbols).

As described above, in some aspects a duplex pattern indicated by the configuration information may be a dynamic duplex pattern. A dynamic duplex pattern is a pattern in which at least some symbols are configured as flexible symbols (e.g., F symbols), such as for a purpose of enabling adaptation of the duplex slot format, among other examples (e.g., the dynamic duplex pattern may include F symbols that may be used as X symbols when more FD symbols are needed or as non-SBFD symbols (e.g., D or U symbols) based on heavy downlink or uplink traffic, among other examples). For example, a dynamic duplex pattern configured as DFXXU may be used as DDXXU (by dynamically converting the flexible slot to a downlink slot) or DXXXU (by dynamically converting the flexible slot to an SBFD slot), among other examples.

As shown by the example dynamic duplex pattern 615 in FIG. 6A, a dynamic duplex pattern may include D symbols at a beginning of the pattern, a first set of F symbols following the D symbols and preceding any X symbols that are in a middle of the pattern, and a second set of F symbols following the X symbols and preceding any U symbols that are at an end of the pattern. In some aspects, a dynamic duplex pattern (e.g., dynamic duplex pattern 615, or a similar pattern) may start with D, F, or X symbols, and may end with F, X, or U symbols. In such aspects, the flexible symbols before the X symbols may be dynamically converted to downlink symbols or SBFD symbols, and the flexible symbols after the X symbols may be dynamically converted to uplink symbols or SBFD symbols.

In some aspects, such as aspects associated with a dynamic duplex pattern (e.g., dynamic duplex pattern 615) the configuration information may indicate a selected TDD pattern or SBFD pattern by indicating the number of downlink slots parameter (e.g., nrofDownlinkSlots), the number of downlink symbols parameter (e.g., nrofDownlinkSymbols), the number of uplink slots parameter (e.g., nrofUplinkSlots), the number of uplink symbols parameter (e.g., nrofUplinkSymbols), the starting SBFD slot parameter (e.g., starting_SBFD_slot), the starting SBFD symbol parameter (e.g., starting_SBFD_symbols), the ending SBFD slot parameter (e.g., ending_SBFD_slot), and the ending SBFD symbol parameter (e.g., ending_SBFD_symbols). In such aspects, the remaining symbols may be implicitly configured as flexible symbols (e.g., any remaining symbols between the zero or more downlink symbols and the SBFD symbols, if any, and between the SBFD symbols and the zero or more uplink symbols may be flexible symbols). Put another way, in such aspects the UE 120 may infer which symbols are flexible symbols based at least in part on a length of the duplex pattern (e.g., indicated by TransmissionPeriodicity), the number of downlink slots parameter (e.g., nrofDownlinkSlots), the number of downlink symbols parameter (e.g., nrofDownlinkSymbols), the number of uplink slots parameter (e.g., nrofUplinkSlots), the number of uplink symbols parameter (e.g., nrofUplinkSymbols), the starting SBFD slot parameter (e.g., starting_SBFD_slot), the starting SBFD symbol parameter (e.g., starting_SBFD_symbols), the ending SBFD slot parameter (e.g., ending_SBFD_slot), and the ending SBFD symbol parameter (e.g., ending_SBFD_symbols).

The UE 120 may configure itself based at least in part on the configuration information. In some aspects, the UE 120 may be configured to perform one or more operations described herein based at least in part on the configuration information.

As indicated by reference number 620, in aspects involving a dynamic duplex pattern (e.g., dynamic duplex pattern 615), the network node 110 may transmit, and the UE 120 may receive, a DCI message (e.g., a group-common DCI) indicating one or more DFIs associated with the dynamic duplex patterns. A DFI (which may correspond to, or which otherwise may be substantially similar to, an SFI) is a signaling mechanism that informs the UE 120 about the format of a specific slot within the duplex pattern, and, more particularly, that indicates whether a specific F slot is to remain an F slot or is to be converted to a D slot, a U slot, or an X slot. In that regard, the DCI message may use a DFI to dynamically indicate that F symbols associated with a slot are to remain F symbols or are to be converted to D symbols, U symbols, or X symbols. Put another way, in some aspects, a DFI may indicate that flexible symbols in a respective slot of the duplex pattern are to be converted to one of downlink symbols, SBFD symbols, or uplink symbols, while, in some other aspects, a DFI may indicate that flexible symbols in a respective slot of the duplex pattern are to remain flexible symbols. Moreover, in some aspects, a DFI may indicate that a slot should have all downlink symbols (e.g., a DFI corresponding to the second slot of the dynamic duplex pattern 615 may indicate that the flexible symbols should be converted to downlink symbols), all SBFD symbols (e.g., a DFI corresponding to the third, sixth, or seventh slot of the dynamic duplex pattern 615 may indicate that the flexible symbols should be converted to SBFD symbols), or all uplink symbols (e.g., a DFI corresponding to the seventh or eighth slot of the dynamic duplex pattern 615 may indicate that the flexible symbols should be converted to uplink symbols).

In some other aspects, a DFI may indicate that a slot should have a combination of SBFD and non-SBFD symbols. For example, a DFI may indicate that the flexible symbols in the second slot of the dynamic duplex pattern 615 are to be converted to SBFD symbols or that the flexible symbols in the third slot of the dynamic duplex pattern 615 are to be converted to downlink symbols, such that the second slot or third slot includes both downlink symbols and SBFD symbols. Similarly, a DFI may indicate that the flexible symbols in the sixth slot of the dynamic duplex pattern 615 are to be converted to uplink symbols or that the flexible symbols in the eighth slot of the dynamic duplex pattern 615 are to be converted to SBFD symbols, such that the sixth slot or eighth slot includes both uplink symbols and SBFD symbols.

In some other aspects, a DFI may indicate that certain flexible symbols should remain flexible symbols. In such aspects, based at least in part on a predefined rule (e.g., a rule promulgated by the 3GPP) or otherwise, the flexible symbols associated with the DFI may be symbols in which no uplink transmissions and no downlink transmissions are permitted to occur. That is, any flexible symbols that are indicated to remain flexible symbols may be treated as guard symbols, such as for a purpose of permitting transition between SBFD and non-SBFD communications. In some other aspects, based at least in part on a predefined rule (e.g., a rule promulgated by the 3GPP) or otherwise, the flexible symbols associated with the DFI may be symbols in which downlink transmissions are permitted to occur but uplink transmissions are not permitted to occur. For example, in any guard symbols (e.g., F symbols) before the SBFD symbols (e.g., X symbols), downlink transmissions may be permitted but uplink transmissions may not be permitted (e.g., the F symbols may be associated with a guard uplink sub-band), such as for a purpose of ensuring uplink time advance or to protect downlink reception. Similarly, in any guard symbols (e.g., F symbols) after the SBFD symbols (e.g., X symbols), uplink transmissions may be permitted but downlink transmissions may not be permitted (e.g., the F symbols may be associated with a guard downlink sub-band). In some other aspects, based at least in part on a predefined rule (e.g., a rule promulgated by the 3GPP) or otherwise, the flexible symbols associated with the DFI may be symbols in which semi-statically scheduled communications are not permitted to occur. For example, all semi-statically scheduled uplink transmissions (e.g., SRS, PUSCH, configured grant PUSCH, or similar transmissions) or all semi-statically scheduled downlink receptions (e.g., semi-persistent scheduling (SPS), PDCCH, CSI-RS, or similar receptions) may be dropped in symbols indicated by a DFI to remain flexible symbols. Additional aspects of dynamically converting flexible symbols to downlink symbols, uplink symbols, SBFD symbols, or flexible symbols based at least in part on receiving a DCI including one or more DFIs are described in more detail below in connection with FIGS. 6B and 6C.

As indicated by reference number 625, the network node 110 and the UE 120 may communicate based at least in part on the configuration information. For example, the network node 110 and the UE 120 may communicate based at least in part on using the selected duplex pattern (e.g., the semi-static or dynamic TDD duplex pattern or SBFD duplex pattern) indicated by the configuration information described above in connection with reference number 605 or the DCI message described above in connection with reference number 620 (e.g., in aspects in which the UE 120 is configured with a dynamic duplex pattern, as described above).

As shown in FIG. 6B, in some aspects, a dynamic duplex pattern may include a slot 635 configured with an SBFD set of symbols 636 having a downlink sub-band (shown using hatching and labeled “D”) and an uplink sub-band (shown using cross-hatching and labeled “U”), and a flexible set of symbols 637 (shown using stippling and labeled “F”) the follows the SBFD set of symbols 636. In a similar manner as described above in connection with reference number 620, in such aspects the UE 120 may receive a DCI message including a DFI associated with the slot 635 that indicates whether the flexible set of symbols 637 is to be converted to an uplink set of symbols (e.g., U symbols), an SBFD set of symbols (e.g., X symbols), or remain a flexible set of symbols (e.g., F symbols).

As indicated by reference number 640, when the DFI indicates that the flexible set of symbols 637 is to be converted to an uplink set of symbols, the entire frequency band associated with the flexible set of symbols may become uplink symbols. As indicated by reference number 645, when the DFI indicates that the flexible set of symbols 637 is to be converted to an SBFD set of symbols, a first sub-band (e.g., a sub-band aligned, in the frequency domain, with the downlink sub-band of the SBFD set of symbols 636) of the flexible set of symbols 637 becomes a downlink sub-band, and a second sub-band (e.g., a sub-band aligned, in the frequency domain, with the uplink sub-band of the SBFD set of symbols 636) of the flexible set of symbols 637 becomes an uplink sub-band. In some aspects, as indicated by reference number 650, when the DFI indicates that the flexible set of symbols 637 is to remain a flexible set of symbols, the entire frequency band associated with the flexible set of symbols may be used as guard symbols (e.g., shown as “G” in FIG. 6B, which includes resources in which no uplink transmissions or downlink receptions are permitted). In some other aspects, as indicated by reference number 655, when the DFI indicates that the flexible set of symbols 637 is to remain a flexible set of symbols, a first sub-band (e.g., a sub-band aligned, in the frequency domain, with the downlink sub-band of the SBFD set of symbols 636) of the flexible set of symbols 637 may be used as a guard sub-band (e.g., a downlink guard sub-band), and a second sub-band (e.g., a sub-band aligned, in the frequency domain, with the uplink sub-band of the SBFD set of symbols 636) of the flexible set of symbols 637 becomes an uplink sub-band to be used for uplink transmissions, as described above in connection with reference number 620.

In some other aspects, as shown in FIG. 6C, a dynamic duplex pattern may include a slot 665 configured with a flexible set of symbols 667, and an SBFD set of symbols 668 having a downlink sub-band and an uplink sub-band that follows the flexible set of symbols 667. In a similar manner as described above in connection with reference number 620, in such aspects the UE 120 may receive a DCI message including a DFI associated with the slot 665 that indicates whether the flexible set of symbols 667 is to be converted to a downlink set of symbols (e.g., D symbols), an SBFD set of symbols (e.g., X symbols), or remain a flexible set of symbols (e.g., F symbols).

As indicated by reference number 670, when the DFI indicates that the flexible set of symbols 667 is to be converted to a downlink set of symbols, the entire frequency band associated with the flexible set of symbols become downlink symbols. As indicated by reference number 675, when the DFI indicates that the flexible set of symbols 667 is to be converted to an SBFD set of symbols, a first sub-band (e.g., a sub-band aligned, in the frequency domain, with the downlink sub-band of the SBFD set of symbols 668) of the flexible set of symbols 667 becomes a downlink sub-band, and a second sub-band (e.g., a sub-band aligned, in the frequency domain, with the uplink sub-band of the SBFD set of symbols 668) of the flexible set of symbols 667 becomes an uplink sub-band. In some aspects, as indicated by reference number 680, when the DFI indicates that the flexible set of symbols 667 is to remain a flexible set of symbols, the entire frequency band associated with the flexible set of symbols may be used as guard symbols (e.g., symbols in which no uplink transmissions or downlink receptions are permitted). In some other aspects, as indicated by reference number 685, when the DFI indicates that the flexible set of symbols 667 is to remain a flexible set of symbols, a first sub-band (e.g., a sub-band aligned, in the frequency domain, with the uplink sub-band of the SBFD set of symbols 668) of the flexible set of symbols 667 may be used as a guard sub-band (e.g., an uplink guard sub-band), and a second sub-band (e.g., a sub-band aligned, in the frequency domain, with the downlink sub-band of the SBFD set of symbols 668) of the flexible set of symbols 667 becomes a downlink sub-band to be used for downlink receptions, as described above in connection with reference number 620.

Based at least in part on the UE 120 and the network node 110 communicating using a duplex pattern that is associated with a format capable of being configured as one or more of TDD patterns or SBFD patterns, the UE 120 or the network node 110 may conserve computing, power, network, or communication resources that may have otherwise been consumed separately signaling TDD pattern configurations and SBFD pattern configurations. For example, based at least in part on the UE 120 and the network node 110 communicating using a duplex pattern that is associated with a format capable of being configured as one or more of TDD patterns or SBFD patterns, the UE 120 and the network node 110 may communicate with reduced signaling overhead, which may conserve computing, power, network, or communication resources, resulting in reduced latency, increased throughput, and otherwise more efficient usage of network resources.

As indicated above, FIGS. 6A-6C are provided as examples. Other examples may differ from what is described with respect to FIGS. 6A-6C.

FIG. 7 is a diagram illustrating an example process 700 performed, for example, at a UE or an apparatus of a UE. Example process 700 is an example where the apparatus or the UE (e.g., UE 120) performs operations associated with duplex pattern configurations for TDD patterns and SBFD patterns.

As shown in FIG. 7, in some aspects, process 700 may include receiving configuration information indicating a first duplex pattern associated with a network node, wherein the first duplex pattern is associated with a format capable of being configured as one or more of TDD patterns or SBFD patterns, and wherein the configuration information indicates, as the first duplex pattern, at least one of a first selected TDD pattern associated with the network node or a first selected SBFD pattern associated with the network node (block 710). For example, the UE (e.g., using reception component 902 or communication manager 906, depicted in FIG. 9) may receive configuration information indicating a first duplex pattern associated with a network node, wherein the first duplex pattern is associated with a format capable of being configured as one or more of TDD patterns or SBFD patterns, and wherein the configuration information indicates, as the first duplex pattern, at least one of a first selected TDD pattern associated with the network node or a first selected SBFD pattern associated with the network node, as described above.

As further shown in FIG. 7, in some aspects, process 700 may include communicating with the network node based at least in part on the configuration information (block 720). For example, the UE (e.g., using reception component 902, transmission component 904, or communication manager 906, depicted in FIG. 9) may communicate with the network node based at least in part on the configuration information, as described above.

Process 700 may include additional aspects, such as any single aspect or any combination of aspects described below or in connection with one or more other processes described elsewhere herein.

In a first aspect, the first duplex pattern is associated with one or more of downlink sets of symbols, uplink sets of symbols, or SBFD sets of symbols, the first duplex pattern begins with one of a downlink set of symbols or an SBFD set of symbols, and the first duplex pattern ends with one of an uplink set of symbols or the SBFD set of symbols.

In a second aspect, alone or in combination with the first aspect, the configuration information indicates the at least one of the first selected TDD pattern or the first selected SBFD pattern by indicating a number of downlink slots parameter that indicates a number of downlink slots at a beginning of the first duplex pattern, a number of downlink symbols parameter that indicates a number of downlink symbols that follow the downlink slots, a number of uplink slots parameter that indicates a number of uplink slots at an end of the first duplex pattern, and a number of uplink symbols parameter that indicates a number of uplink symbols that precede the uplink slots.

In a third aspect, alone or in combination with one or more of the first and second aspects, the configuration information indicates the at least one of the at least one of the first selected TDD pattern or the first selected SBFD pattern by indicating a starting SBFD slot parameter that indicates a first slot index associated with a starting SBFD slot, a starting SBFD symbol parameter that indicates a first symbol index of a starting SBFD symbol associated with the starting SBFD slot, an ending SBFD slot parameter that indicates a second slot index associated with an ending SBFD slot, and an ending SBFD symbol parameter that indicates a second symbol index of an ending SBFD symbol associated with the ending SBFD slot.

In a fourth aspect, alone or in combination with one or more of the first through third aspects, the configuration information indicates the at least one of the first selected TDD pattern or the first selected SBFD pattern by indicating a number of downlink slots parameter that indicates a number of downlink slots at a beginning of the first duplex pattern, a number of downlink symbols parameter that indicates a number of downlink symbols that follow the downlink slots, a starting SBFD symbol parameter that indicates a number of starting SBFD symbols that follow downlink symbols, a number of SBFD slots parameter that indicates a number of SBFD slots that follow the starting SBFD symbols, and an ending SBFD slot parameter that indicates a number of ending SBFD symbols that follow the SBFD slots.

In a fifth aspect, alone or in combination with one or more of the first through fourth aspects, the configuration information indicates the at least one of the first selected TDD pattern or the first selected SBFD pattern by indicating a number of uplink slots parameter that indicates a number of uplink slots at an end of the first duplex pattern, a number of uplink symbols parameter that indicates a number of uplink symbols that precede the uplink slots, an ending SBFD slot parameter that indicates a number of ending SBFD symbols that precede the uplink symbols, a number of SBFD slots parameter that indicates a number of SBFD slots that precede the ending SBFD symbols, and a starting SBFD symbol parameter that indicates a number of starting SBFD symbols that precede the SBFD slots.

In a sixth aspect, alone or in combination with one or more of the first through fifth aspects, the configuration information further indicates a number of guard symbols parameter that indicates at least one of a first quantity of guard symbols that follow a last downlink symbol in the at least one of the first selected TDD pattern or the first selected SBFD pattern, or a second quantity of guard symbols that occur before a first uplink symbol in the at least one of the first selected TDD pattern or the first selected SBFD pattern.

In a seventh aspect, alone or in combination with one or more of the first through sixth aspects, receiving the configuration information includes receiving the configuration information via at least one of a system information block 1 or a cell-specific dedicated configuration.

In an eighth aspect, alone or in combination with one or more of the first through seventh aspects, the first duplex pattern is associated with one or more of: a downlink set of symbols; a first flexible set of symbols, wherein the first flexible set of symbols is capable of being converted to downlink symbols or SBFD symbols; an SBFD set of symbols; a second flexible set of symbols, wherein the second flexible set of symbols is capable of being converted to SBFD symbols or uplink symbols; or an uplink set of symbols.

In a ninth aspect, alone or in combination with one or more of the first through eighth aspects, the configuration information indicates the at least one of the first selected TDD pattern or the first selected SBFD pattern by indicating a number of downlink slots parameter that indicates a number of downlink slots at a beginning of the first duplex pattern, a number of downlink symbols parameter that indicates a number of downlink symbols that follow the downlink slots, a number of uplink slots parameter that indicates a number of uplink slots at an end of the first duplex pattern, a number of uplink symbols parameter that indicates a number of uplink symbols that precede the uplink slots, a starting SBFD slot parameter that indicates a first slot index associated with a starting SBFD slot, a starting SBFD symbol parameter that indicates a first symbol index of a starting SBFD symbol associated with the starting SBFD slot, an ending SBFD slot parameter that indicates a second slot index associated with an ending SBFD slot, and an ending SBFD symbol parameter that indicates a second symbol index of an ending SBFD symbol associated with the ending SBFD slot.

In a tenth aspect, alone or in combination with one or more of the first through ninth aspects, process 700 includes receiving a downlink control information message indicating one or more DFIs, wherein each DFI, of the one or more DFIs, indicates that flexible symbols in a respective slot of the first duplex pattern are to be converted to one of downlink symbols, SBFD symbols, or uplink symbols.

In an eleventh aspect, alone or in combination with one or more of the first through tenth aspects, process 700 includes receiving a downlink control information message indicating one or more DFIs, wherein at least one DFI, of the one or more DFIs, indicates that flexible symbols in a respective slot of the first duplex pattern are to remain flexible symbols.

In a twelfth aspect, alone or in combination with one or more of the first through eleventh aspects, based at least in part on a predefined rule, the flexible symbols associated with the at least one DFI are associated with one of: symbols in which no uplink transmissions and no downlink transmissions are permitted to occur, symbols in which downlink transmissions are permitted to occur and uplink transmissions are not permitted to occur, symbols in which uplink transmissions are permitted to occur and downlink transmissions are not permitted to occur, or symbols in which semi-statically scheduled communications are not permitted to occur.

In a thirteenth aspect, alone or in combination with one or more of the first through twelfth aspects, the configuration information further indicates a second duplex pattern associated with the network node, the second duplex pattern is associated with the format capable of being configured as one or more of TDD patterns or SBFD patterns, and the configuration information indicates, as the second duplex pattern, at least one of a second selected TDD pattern associated with the network node or a second selected SBFD pattern associated with the network node.

In a fourteenth aspect, alone or in combination with one or more of the first through thirteenth aspects, based at least in part on a pre-defined rule, one of the first duplex pattern and the second duplex pattern are associated with a semi-static duplex pattern, the first duplex pattern and the second duplex pattern are associated with a dynamic duplex pattern, or the first duplex pattern is associated with a semi-static duplex pattern and the second duplex pattern is associated with a dynamic duplex pattern.

In a fifteenth aspect, alone or in combination with one or more of the first through fourteenth aspects, based at least in part on a predefined rule, one of: the first duplex pattern is associated with the first selected SBFD pattern and the second duplex pattern is associated with the second selected TDD pattern; the first duplex pattern is associated with the first selected SBFD pattern and the second duplex pattern is associated with the second selected SBFD pattern; or the first duplex pattern is associated with the one of the first selected TDD pattern or the first selected SBFD pattern independently of whether the second duplex pattern is associated with the one of the second selected TDD pattern or the second selected SBFD pattern, and the second duplex pattern is associated with the one of the second selected TDD pattern or the second selected SBFD pattern independently of whether the first duplex pattern is associated with the one of the first selected TDD pattern or the first selected SBFD pattern.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, at a network node or an apparatus of a network node. Example process 800 is an example where the apparatus or the network node (e.g., network node 110) performs operations associated with duplex pattern configurations for TDD patterns and SBFD patterns.

As shown in FIG. 8, in some aspects, process 800 may include transmitting, to a UE, configuration information indicating a first duplex pattern associated with the network node, wherein the first duplex pattern is associated with a format capable of being configured as one or more of TDD patterns or SBFD patterns, and wherein the configuration information indicates, as the first duplex pattern, at least one of a first selected TDD pattern associated with the network node or a first selected SBFD pattern associated with the network node (block 810). For example, the network node (e.g., using transmission component 1004 or communication manager 1006, depicted in FIG. 10) may transmit, to a UE, configuration information indicating a first duplex pattern associated with the network node, wherein the first duplex pattern is associated with a format capable of being configured as one or more of TDD patterns or SBFD patterns, and wherein the configuration information indicates, as the first duplex pattern, at least one of a first selected TDD pattern associated with the network node or a first selected SBFD pattern associated with the network node, as described above.

As further shown in FIG. 8, in some aspects, process 800 may include communicating with the UE based at least in part on the configuration information (block 820). For example, the network node (e.g., using reception component 1002, transmission component 1004, or communication manager 1006, depicted in FIG. 10) may communicate with the UE based at least in part on the configuration information, as described above.

Process 800 may include additional aspects, such as any single aspect or any combination of aspects described below or in connection with one or more other processes described elsewhere herein.

In a first aspect, the first duplex pattern is associated with one or more of downlink sets of symbols, uplink sets of symbols, or SBFD sets of symbols, the first duplex pattern begins with one of a downlink set of symbols or an SBFD set of symbols, and the first duplex pattern ends with one of an uplink set of symbols or the SBFD set of symbols.

In a second aspect, alone or in combination with the first aspect, the configuration information indicates the at least one of the first selected TDD pattern or the first selected SBFD pattern by indicating a number of downlink slots parameter that indicates a number of downlink slots at a beginning of the first duplex pattern, a number of downlink symbols parameter that indicates a number of downlink symbols that follow the downlink slots, a number of uplink slots parameter that indicates a number of uplink slots at an end of the first duplex pattern, and a number of uplink symbols parameter that indicates a number of uplink symbols that precede the uplink slots.

In a third aspect, alone or in combination with one or more of the first and second aspects, the configuration information indicates the at least one of the at least one of the first selected TDD pattern or the first selected SBFD pattern by indicating a starting SBFD slot parameter that indicates a first slot index associated with a starting SBFD slot, a starting SBFD symbol parameter that indicates a first symbol index of a starting SBFD symbol associated with the starting SBFD slot, an ending SBFD slot parameter that indicates a second slot index associated with an ending SBFD slot, and an ending SBFD symbol parameter that indicates a second symbol index of an ending SBFD symbol associated with the ending SBFD slot.

In a fourth aspect, alone or in combination with one or more of the first through third aspects, the configuration information indicates the at least one of the first selected TDD pattern or the first selected SBFD pattern by indicating a number of downlink slots parameter that indicates a number of downlink slots at a beginning of the first duplex pattern, a number of downlink symbols parameter that indicates a number of downlink symbols that follow the downlink slots, a starting SBFD symbol parameter that indicates a number of starting SBFD symbols that follow downlink symbols, a number of SBFD slots parameter that indicates a number of SBFD slots that follow the starting SBFD symbols, and an ending SBFD slot parameter that indicates a number of ending SBFD symbols that follow the SBFD slots.

In a fifth aspect, alone or in combination with one or more of the first through fourth aspects, the configuration information indicates the at least one of the first selected TDD pattern or the first selected SBFD pattern by indicating a number of uplink slots parameter that indicates a number of uplink slots at an end of the first duplex pattern, a number of uplink symbols parameter that indicates a number of uplink symbols that precede the uplink slots, an ending SBFD slot parameter that indicates a number of ending SBFD symbols that precede the uplink symbols, a number of SBFD slots parameter that indicates a number of SBFD slots that precede the ending SBFD symbols, and a starting SBFD symbol parameter that indicates a number of starting SBFD symbols that precede the SBFD slots.

In a sixth aspect, alone or in combination with one or more of the first through fifth aspects, the configuration information further indicates a number of guard symbols parameter that indicates at least one of a first quantity of guard symbols that follow a last downlink symbol in the at least one of the first selected TDD pattern or the first selected SBFD pattern, or a second quantity of guard symbols that occur before a first uplink symbol in the at least one of the first selected TDD pattern or the first selected SBFD pattern.

In a seventh aspect, alone or in combination with one or more of the first through sixth aspects, transmitting the configuration information includes transmitting the configuration information via at least one of a system information block 1 or a cell-specific dedicated configuration.

In an eighth aspect, alone or in combination with one or more of the first through seventh aspects, the first duplex pattern is associated with one or more of: a downlink set of symbols; a first flexible set of symbols, wherein the first flexible set of symbols is capable of being converted to downlink symbols or SBFD symbols; an SBFD set of symbols; a second flexible set of symbols, wherein the second flexible set of symbols is capable of being converted to SBFD symbols or uplink symbols; or an uplink set of symbols.

In a ninth aspect, alone or in combination with one or more of the first through eighth aspects, the configuration information indicates the at least one of the first selected TDD pattern or the first selected SBFD pattern by indicating a number of downlink slots parameter that indicates a number of downlink slots at a beginning of the first duplex pattern, a number of downlink symbols parameter that indicates a number of downlink symbols that follow the downlink slots, a number of uplink slots parameter that indicates a number of uplink slots at an end of the first duplex pattern, a number of uplink symbols parameter that indicates a number of uplink symbols that precede the uplink slots, a starting SBFD slot parameter that indicates a first slot index associated with a starting SBFD slot, a starting SBFD symbol parameter that indicates a first symbol index of a starting SBFD symbol associated with the starting SBFD slot, an ending SBFD slot parameter that indicates a second slot index associated with an ending SBFD slot, and an ending SBFD symbol parameter that indicates a second symbol index of an ending SBFD symbol associated with the ending SBFD slot.

In a tenth aspect, alone or in combination with one or more of the first through ninth aspects, process 800 includes transmitting, to the UE, a downlink control information message indicating one or more DFIs, wherein each DFI, of the one or more DFIs, indicates that flexible symbols in a respective slot of the first duplex pattern are to be converted to one of downlink symbols, SBFD symbols, or uplink symbols.

In an eleventh aspect, alone or in combination with one or more of the first through tenth aspects, process 800 includes transmitting, to the UE, a downlink control information message indicating one or more DFIs, wherein at least one DFI, of the one or more DFIs, indicates that flexible symbols in a respective slot of the first duplex pattern are to remain flexible symbols.

In a twelfth aspect, alone or in combination with one or more of the first through eleventh aspects, based at least in part on a predefined rule, the flexible symbols associated with the at least one DFI are associated with one of symbols in which no uplink transmissions and no downlink transmissions are permitted to occur, symbols in which downlink transmissions are permitted to occur and uplink transmissions are not permitted to occur, symbols in which uplink transmissions are permitted to occur and downlink transmissions are not permitted to occur, or symbols in which semi-statically scheduled communications are not permitted to occur.

In a thirteenth aspect, alone or in combination with one or more of the first through twelfth aspects, the configuration information further indicates a second duplex pattern associated with the network node, wherein the second duplex pattern is associated with the format capable of being configured as one or more of TDD patterns or SBFD patterns, and wherein the configuration information indicates, as the second duplex pattern, at least one of a second selected TDD pattern associated with the network node or a second selected SBFD pattern associated with the network node.

In a fourteenth aspect, alone or in combination with one or more of the first through thirteenth aspects, based at least in part on a pre-defined rule, one of the first duplex pattern and the second duplex pattern are associated with a semi-static duplex pattern, the first duplex pattern and the second duplex pattern are associated with a dynamic duplex pattern, or the first duplex pattern is associated with a semi-static duplex pattern and the second duplex pattern is associated with a dynamic duplex pattern.

In a fifteenth aspect, alone or in combination with one or more of the first through fourteenth aspects, based at least in part on a predefined rule, one of: the first duplex pattern is associated with the first selected SBFD pattern and the second duplex pattern is associated with the second selected TDD pattern; the first duplex pattern is associated with the first selected SBFD pattern and the second duplex pattern is associated with the second selected SBFD pattern; or the first duplex pattern is associated with the one of the first selected TDD pattern or the first selected SBFD pattern independently of whether the second duplex pattern is associated with the one of the second selected TDD pattern or the second selected SBFD pattern, and the second duplex pattern is associated with the one of the second selected TDD pattern or the second selected SBFD pattern independently of whether the first duplex pattern is associated with the one of the first selected TDD pattern or the first selected SBFD pattern.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication. The apparatus 900 may be a UE, or a UE may include the apparatus 900. In some aspects, the apparatus 900 includes a reception component 902, a transmission component 904, or a communication manager 906, which may be in communication with one another (for example, via one or more buses or one or more other components). In some aspects, the communication manager 906 is the communication manager 150 described in connection with FIG. 1. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 140 described in connection with FIG. 1) of the UE.

In some aspects, the apparatus 900 may be configured to perform one or more operations described herein in connection with FIGS. 6A-6C. Additionally, or alternatively, the apparatus 900 may be configured to perform one or more processes described herein, such as process 700 of FIG. 7. In some aspects, the apparatus 900 or one or more components shown in FIG. 9 may include one or more components of the UE described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the UE described above in connection with FIG. 1, such as a radio, one or more RF chains, one or more transceivers, or one or more modems, each of which may in turn be coupled with one or more antennas of the UE.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 904 may be co-located with the reception component 902.

The communication manager 906 may support operations of the reception component 902 or the transmission component 904. For example, the communication manager 906 may receive information associated with configuring reception of communications by the reception component 902 or transmission of communications by the transmission component 904. Additionally, or alternatively, the communication manager 906 may generate or provide control information to the reception component 902 or the transmission component 904 to control reception or transmission of communications.

The reception component 902 may receive configuration information indicating a first duplex pattern associated with a network node, wherein the first duplex pattern is associated with a format capable of being configured as one or more of TDD patterns or SBFD patterns, and wherein the configuration information indicates, as the first duplex pattern, at least one of a first selected TDD pattern associated with the network node or a first selected SBFD pattern associated with the network node. The reception component 902 or the transmission component 904 may communicate with the network node based at least in part on the configuration information.

The reception component 902 may receive a downlink control information message indicating one or more DFIs, wherein each DFI, of the one or more DFIs, indicates that flexible symbols in a respective slot of the first duplex pattern are to be converted to one of: downlink symbols, SBFD symbols, or uplink symbols.

The reception component 902 may receive a downlink control information message indicating one or more DFIs, wherein at least one DFI, of the one or more DFIs, indicates that flexible symbols in a respective slot of the first duplex pattern are to remain flexible symbols.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication. The apparatus 1000 may be a network node, or a network node may include the apparatus 1000. In some aspects, the apparatus 1000 includes a reception component 1002, a transmission component 1004, or a communication manager 1006, which may be in communication with one another (for example, via one or more buses or one or more other components). In some aspects, the communication manager 1006 is the communication manager 155 described in connection with FIG. 1. As shown, the apparatus 1000 may communicate with another apparatus 1008, such as a UE or a network node (such as a CU, a DU, an RU, or a base station), using the reception component 1002 and the transmission component 1004. The communication manager 1006 may be included in, or implemented via, a processing system (for example, the processing system 145 described in connection with FIG. 1) of the network node.

In some aspects, the apparatus 1000 may be configured to perform one or more operations described herein in connection with FIGS. 6A-6C. Additionally, or alternatively, the apparatus 1000 may be configured to perform one or more processes described herein, such as process 800 of FIG. 8. In some aspects, the apparatus 1000 or one or more components shown in FIG. 10 may include one or more components of the network node described in connection with FIG. 1. Additionally, or alternatively, one or more components shown in FIG. 10 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications, and may provide the processed signals to the one or more other components of the apparatus 1000. In some aspects, the reception component 1002 may include one or more components of the network node described above in connection with FIG. 1, such as a radio, one or more RF chains, one or more transceivers, or one or more modems, each of which may in turn be coupled with one or more antennas of the network node. In some aspects, the reception component 1002 or the transmission component 1004 may include or may be included in a network interface. The network interface may be configured to obtain or output signals for the apparatus 1000 via one or more communications links, such as a backhaul link, a midhaul link, or a fronthaul link.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications, and may transmit the processed signals to the apparatus 1008. In some aspects, the transmission component 1004 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1004 may be co-located with the reception component 1002.

The communication manager 1006 may support operations of the reception component 1002 or the transmission component 1004. For example, the communication manager 1006 may receive information associated with configuring reception of communications by the reception component 1002 or transmission of communications by the transmission component 1004. Additionally, or alternatively, the communication manager 1006 may generate or provide control information to the reception component 1002 or the transmission component 1004 to control reception or transmission of communications.

The transmission component 1004 may transmit, to a UE, configuration information indicating a first duplex pattern associated with the network node, wherein the first duplex pattern is associated with a format capable of being configured as one or more of TDD patterns or SBFD patterns, and wherein the configuration information indicates, as the first duplex pattern, at least one of a first selected TDD pattern associated with the network node or a first selected SBFD pattern associated with the network node. The reception component 1002 or the transmission component 1004 may communicate with the UE based at least in part on the configuration information.

The transmission component 1004 may transmit, to the UE, a downlink control information message indicating one or more DFIs, wherein each DFI, of the one or more DFIs, indicates that flexible symbols in a respective slot of the first duplex pattern are to be converted to one of: downlink symbols, SBFD symbols, or uplink symbols.

The transmission component 1004 may transmit, to the UE, a downlink control information message indicating one or more DFIs, wherein at least one DFI, of the one or more DFIs, indicates that flexible symbols in a respective slot of the first duplex pattern are to remain flexible symbols.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a user equipment (UE), comprising: receiving configuration information indicating a first duplex pattern associated with a network node, wherein the first duplex pattern is associated with a format capable of being configured as one or more of time division duplex (TDD) patterns or sub-band full duplex (SBFD) patterns, and wherein the configuration information indicates, as the first duplex pattern, at least one of a first selected TDD pattern associated with the network node or a first selected SBFD pattern associated with the network node; and communicating with the network node based at least in part on the configuration information.

Aspect 2: The method of Aspect 1, wherein the first duplex pattern is associated with one or more of downlink sets of symbols, uplink sets of symbols, or SBFD sets of symbols, wherein the first duplex pattern begins with one of a downlink set of symbols or an SBFD set of symbols, and wherein the first duplex pattern ends with one of an uplink set of symbols or the SBFD set of symbols.

Aspect 3: The method of any of Aspects 1-2, wherein the configuration information indicates the at least one of the first selected TDD pattern or the first selected SBFD pattern by indicating: a number of downlink slots parameter that indicates a number of downlink slots at a beginning of the first duplex pattern, a number of downlink symbols parameter that indicates a number of downlink symbols that follow the downlink slots, a number of uplink slots parameter that indicates a number of uplink slots at an end of the first duplex pattern, and a number of uplink symbols parameter that indicates a number of uplink symbols that precede the uplink slots.

Aspect 4: The method of any of Aspects 1-3, wherein the configuration information indicates the at least one of the at least one of the first selected TDD pattern or the first selected SBFD pattern by indicating: a starting SBFD slot parameter that indicates a first slot index associated with a starting SBFD slot, a starting SBFD symbol parameter that indicates a first symbol index of a starting SBFD symbol associated with the starting SBFD slot, an ending SBFD slot parameter that indicates a second slot index associated with an ending SBFD slot, and an ending SBFD symbol parameter that indicates a second symbol index of an ending SBFD symbol associated with the ending SBFD slot.

Aspect 5: The method of any of Aspects 1-4, wherein the configuration information indicates the at least one of the first selected TDD pattern or the first selected SBFD pattern by indicating: a number of downlink slots parameter that indicates a number of downlink slots at a beginning of the first duplex pattern, a number of downlink symbols parameter that indicates a number of downlink symbols that follow the downlink slots, a starting SBFD symbol parameter that indicates a number of starting SBFD symbols that follow downlink symbols, a number of SBFD slots parameter that indicates a number of SBFD slots that follow the starting SBFD symbols, and an ending SBFD slot parameter that indicates a number of ending SBFD symbols that follow the SBFD slots.

Aspect 6: The method of any of Aspects 1-5, wherein the configuration information indicates the at least one of the first selected TDD pattern or the first selected SBFD pattern by indicating: a number of uplink slots parameter that indicates a number of uplink slots at an end of the first duplex pattern, a number of uplink symbols parameter that indicates a number of uplink symbols that precede the uplink slots, an ending SBFD slot parameter that indicates a number of ending SBFD symbols that precede the uplink symbols, a number of SBFD slots parameter that indicates a number of SBFD slots that precede the ending SBFD symbols, and a starting SBFD symbol parameter that indicates a number of starting SBFD symbols that precede the SBFD slots.

Aspect 7: The method of any of Aspects 1-6, wherein the configuration information further indicates a number of guard symbols parameter that indicates at least one of: a first quantity of guard symbols that follow a last downlink symbol in the at least one of the first selected TDD pattern or the first selected SBFD pattern, or a second quantity of guard symbols that occur before a first uplink symbol in the at least one of the first selected TDD pattern or the first selected SBFD pattern.

Aspect 8: The method of any of Aspects 1-7, wherein receiving the configuration information includes receiving the configuration information via at least one of a system information block 1 or a cell-specific dedicated configuration.

Aspect 9: The method of any of Aspects 1-8, wherein the first duplex pattern is associated with one or more of: a downlink set of symbols, a first flexible set of symbols, wherein the first flexible set of symbols is capable of being converted to downlink symbols or SBFD symbols, an SBFD set of symbols, a second flexible set of symbols, wherein the second flexible set of symbols is capable of being converted to SBFD symbols or uplink symbols, or an uplink set of symbols.

Aspect 10: The method of Aspect 9, wherein the configuration information indicates the at least one of the first selected TDD pattern or the first selected SBFD pattern by indicating: a number of downlink slots parameter that indicates a number of downlink slots at a beginning of the first duplex pattern, a number of downlink symbols parameter that indicates a number of downlink symbols that follow the downlink slots, a number of uplink slots parameter that indicates a number of uplink slots at an end of the first duplex pattern, a number of uplink symbols parameter that indicates a number of uplink symbols that precede the uplink slots, a starting SBFD slot parameter that indicates a first slot index associated with a starting SBFD slot, a starting SBFD symbol parameter that indicates a first symbol index of a starting SBFD symbol associated with the starting SBFD slot, an ending SBFD slot parameter that indicates a second slot index associated with an ending SBFD slot, and an ending SBFD symbol parameter that indicates a second symbol index of an ending SBFD symbol associated with the ending SBFD slot.

Aspect 11: The method of Aspect 9, further comprising receiving a downlink control information message indicating one or more duplex format indicators (DFIs), wherein each DFI, of the one or more DFIs, indicates that flexible symbols in a respective slot of the first duplex pattern are to be converted to one of: downlink symbols, SBFD symbols, or uplink symbols.

Aspect 12: The method of Aspect 9, further comprising receiving a downlink control information message indicating one or more duplex format indicators (DFIs), wherein at least one DFI, of the one or more DFIs, indicates that flexible symbols in a respective slot of the first duplex pattern are to remain flexible symbols.

Aspect 13: The method of Aspect 12, wherein, based at least in part on a predefined rule, the flexible symbols associated with the at least one DFI are associated with one of: symbols in which no uplink transmissions and no downlink transmissions are permitted to occur, symbols in which downlink transmissions are permitted to occur and uplink transmissions are not permitted to occur, symbols in which uplink transmissions are permitted to occur and downlink transmissions are not permitted to occur, or symbols in which semi-statically scheduled communications are not permitted to occur.

Aspect 14: The method of any of Aspects 1-13, wherein the configuration information further indicates a second duplex pattern associated with the network node, wherein the second duplex pattern is associated with the format capable of being configured as one or more of TDD patterns or SBFD patterns, and wherein the configuration information indicates, as the second duplex pattern, at least one of a second selected TDD pattern associated with the network node or a second selected SBFD pattern associated with the network node.

Aspect 15: The method of Aspect 14, wherein, based at least in part on a pre-defined rule, one of: the first duplex pattern and the second duplex pattern are associated with a semi-static duplex pattern, the first duplex pattern and the second duplex pattern are associated with a dynamic duplex pattern, or the first duplex pattern is associated with a semi-static duplex pattern and the second duplex pattern is associated with a dynamic duplex pattern.

Aspect 16: The method of Aspect 14, wherein, based at least in part on a predefined rule, one of: the first duplex pattern is associated with the first selected SBFD pattern and the second duplex pattern is associated with the second selected TDD pattern, the first duplex pattern is associated with the first selected SBFD pattern and the second duplex pattern is associated with the second selected SBFD pattern, or the first duplex pattern is associated with the one of the first selected TDD pattern or the first selected SBFD pattern independently of whether the second duplex pattern is associated with the one of the second selected TDD pattern or the second selected SBFD pattern, and the second duplex pattern is associated with the one of the second selected TDD pattern or the second selected SBFD pattern independently of whether the first duplex pattern is associated with the one of the first selected TDD pattern or the first selected SBFD pattern.

Aspect 17: A method of wireless communication performed by a network node, comprising: transmitting, to a user equipment (UE), configuration information indicating a first duplex pattern associated with the network node, wherein the first duplex pattern is associated with a format capable of being configured as one or more of time division duplex (TDD) patterns or sub-band full duplex (SBFD) patterns, and wherein the configuration information indicates, as the first duplex pattern, at least one of a first selected TDD pattern associated with the network node or a first selected SBFD pattern associated with the network node; and communicating with the UE based at least in part on the configuration information.

Aspect 18: The method of Aspect 17, wherein the first duplex pattern is associated with one or more of downlink sets of symbols, uplink sets of symbols, or SBFD sets of symbols, wherein the first duplex pattern begins with one of a downlink set of symbols or an SBFD set of symbols, and wherein the first duplex pattern ends with one of an uplink set of symbols or the SBFD set of symbols.

Aspect 19: The method of any of Aspects 17-18, wherein the configuration information indicates the at least one of the first selected TDD pattern or the first selected SBFD pattern by indicating: a number of downlink slots parameter that indicates a number of downlink slots at a beginning of the first duplex pattern, a number of downlink symbols parameter that indicates a number of downlink symbols that follow the downlink slots, a number of uplink slots parameter that indicates a number of uplink slots at an end of the first duplex pattern, and a number of uplink symbols parameter that indicates a number of uplink symbols that precede the uplink slots.

Aspect 20: The method of any of Aspects 17-19, wherein the configuration information indicates the at least one of the at least one of the first selected TDD pattern or the first selected SBFD pattern by indicating: a starting SBFD slot parameter that indicates a first slot index associated with a starting SBFD slot, a starting SBFD symbol parameter that indicates a first symbol index of a starting SBFD symbol associated with the starting SBFD slot, an ending SBFD slot parameter that indicates a second slot index associated with an ending SBFD slot, and an ending SBFD symbol parameter that indicates a second symbol index of an ending SBFD symbol associated with the ending SBFD slot.

Aspect 21: The method of any of Aspects 17-20, wherein the configuration information indicates the at least one of the first selected TDD pattern or the first selected SBFD pattern by indicating: a number of downlink slots parameter that indicates a number of downlink slots at a beginning of the first duplex pattern, a number of downlink symbols parameter that indicates a number of downlink symbols that follow the downlink slots, a starting SBFD symbol parameter that indicates a number of starting SBFD symbols that follow downlink symbols, a number of SBFD slots parameter that indicates a number of SBFD slots that follow the starting SBFD symbols, and an ending SBFD slot parameter that indicates a number of ending SBFD symbols that follow the SBFD slots.

Aspect 22: The method of any of Aspects 17-21, wherein the configuration information indicates the at least one of the first selected TDD pattern or the first selected SBFD pattern by indicating: a number of uplink slots parameter that indicates a number of uplink slots at an end of the first duplex pattern, a number of uplink symbols parameter that indicates a number of uplink symbols that precede the uplink slots, an ending SBFD slot parameter that indicates a number of ending SBFD symbols that precede the uplink symbols, a number of SBFD slots parameter that indicates a number of SBFD slots that precede the ending SBFD symbols, and a starting SBFD symbol parameter that indicates a number of starting SBFD symbols that precede the SBFD slots.

Aspect 23: The method of any of Aspects 17-22, wherein the configuration information further indicates a number of guard symbols parameter that indicates at least one of: a first quantity of guard symbols that follow a last downlink symbol in the at least one of the first selected TDD pattern or the first selected SBFD pattern, or a second quantity of guard symbols that occur before a first uplink symbol in the at least one of the first selected TDD pattern or the first selected SBFD pattern.

Aspect 24: The method of any of Aspects 17-23, wherein transmitting the configuration information includes transmitting the configuration information via at least one of a system information block 1 or a cell-specific dedicated configuration.

Aspect 25: The method of any of Aspects 17-24, wherein the first duplex pattern is associated with one or more of: a downlink set of symbols, a first flexible set of symbols, wherein the first flexible set of symbols is capable of being converted to downlink symbols or SBFD symbols, an SBFD set of symbols, a second flexible set of symbols, wherein the second flexible set of symbols is capable of being converted to SBFD symbols or uplink symbols, or an uplink set of symbols.

Aspect 26: The method of Aspect 25, wherein the configuration information indicates the at least one of the first selected TDD pattern or the first selected SBFD pattern by indicating: a number of downlink slots parameter that indicates a number of downlink slots at a beginning of the first duplex pattern, a number of downlink symbols parameter that indicates a number of downlink symbols that follow the downlink slots, a number of uplink slots parameter that indicates a number of uplink slots at an end of the first duplex pattern, a number of uplink symbols parameter that indicates a number of uplink symbols that precede the uplink slots, a starting SBFD slot parameter that indicates a first slot index associated with a starting SBFD slot, a starting SBFD symbol parameter that indicates a first symbol index of a starting SBFD symbol associated with the starting SBFD slot, an ending SBFD slot parameter that indicates a second slot index associated with an ending SBFD slot, and an ending SBFD symbol parameter that indicates a second symbol index of an ending SBFD symbol associated with the ending SBFD slot.

Aspect 27: The method of Aspect 25, further comprising transmitting, to the UE, a downlink control information message indicating one or more duplex format indicators (DFIs), wherein each DFI, of the one or more DFIs, indicates that flexible symbols in a respective slot of the first duplex pattern are to be converted to one of: downlink symbols, SBFD symbols, or uplink symbols.

Aspect 28: The method of Aspect 25, further comprising transmitting, to the UE, a downlink control information message indicating one or more duplex format indicators (DFIs), wherein at least one DFI, of the one or more DFIs, indicates that flexible symbols in a respective slot of the first duplex pattern are to remain flexible symbols.

Aspect 29: The method of Aspect 28, wherein, based at least in part on a predefined rule, the flexible symbols associated with the at least one DFI are associated with one of: symbols in which no uplink transmissions and no downlink transmissions are permitted to occur, symbols in which downlink transmissions are permitted to occur and uplink transmissions are not permitted to occur, symbols in which uplink transmissions are permitted to occur and downlink transmissions are not permitted to occur, or symbols in which semi-statically scheduled communications are not permitted to occur.

Aspect 30: The method of any of Aspects 17-29, wherein the configuration information further indicates a second duplex pattern associated with the network node, wherein the second duplex pattern is associated with the format capable of being configured as one or more of TDD patterns or SBFD patterns, and wherein the configuration information indicates, as the second duplex pattern, at least one of a second selected TDD pattern associated with the network node or a second selected SBFD pattern associated with the network node.

Aspect 31: The method of Aspect 30, wherein, based at least in part on a pre-defined rule, one of: the first duplex pattern and the second duplex pattern are associated with a semi-static duplex pattern, the first duplex pattern and the second duplex pattern are associated with a dynamic duplex pattern, or the first duplex pattern is associated with a semi-static duplex pattern and the second duplex pattern is associated with a dynamic duplex pattern.

Aspect 32: The method of Aspect 30, wherein, based at least in part on a predefined rule, one of: the first duplex pattern is associated with the first selected SBFD pattern and the second duplex pattern is associated with the second selected TDD pattern, the first duplex pattern is associated with the first selected SBFD pattern and the second duplex pattern is associated with the second selected SBFD pattern, or the first duplex pattern is associated with the one of the first selected TDD pattern or the first selected SBFD pattern independently of whether the second duplex pattern is associated with the one of the second selected TDD pattern or the second selected SBFD pattern, and the second duplex pattern is associated with the one of the second selected TDD pattern or the second selected SBFD pattern independently of whether the first duplex pattern is associated with the one of the first selected TDD pattern or the first selected SBFD pattern.

Aspect 33: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-32.

Aspect 34: An apparatus for wireless communication at a device, the apparatus comprising one or more memories and one or more processors coupled to the one or more memories, the one or more processors configured to cause the device to perform the method of one or more of Aspects 1-32.

Aspect 35: An apparatus for wireless communication, the apparatus comprising at least one means for performing the method of one or more of Aspects 1-32.

Aspect 36: A non-transitory computer-readable medium storing code for wireless communication, the code comprising instructions executable by one or more processors to perform the method of one or more of Aspects 1-32.

Aspect 37: A non-transitory computer-readable medium storing a set of instructions for wireless communication, the set of instructions comprising one or more instructions that, when executed by one or more processors of a device, cause the device to perform the method of one or more of Aspects 1-32.

Aspect 38: A device for wireless communication, the device comprising a processing system that includes one or more processors and one or more memories coupled with the one or more processors, the processing system configured to cause the device to perform the method of one or more of Aspects 1-32.

Aspect 39: An apparatus for wireless communication at a device, the apparatus comprising one or more memories and one or more processors coupled to the one or more memories, the one or more processors individually or collectively configured to cause the device to perform the method of one or more of Aspects 1-32.

Aspect 40: A device comprising a processing system that includes one or more processors and one or more code-storing memories coupled with the one or more processors, the processing system configured to cause the device to perform the method of one or more of Aspects 1-32.

Aspect 41: A device comprising a processing system that includes processor circuitry and code-storing memory circuitry, the processing system configured to cause the device to perform the method of one or more of Aspects 1-32.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
a processing system that includes one or more processors and one or more code-storing memories coupled with the one or more processors, the processing system configured to cause the UE to:
receive configuration information indicating a first duplex pattern associated with a network node,
wherein the first duplex pattern is associated with a format capable of being configured as one or more of time division duplex (TDD) patterns or sub-band full duplex (SBFD) patterns, and
wherein the configuration information indicates, as the first duplex pattern, at least one of a first selected TDD pattern associated with the network node or a first selected SBFD pattern associated with the network node; and
communicate with the network node based at least in part on the configuration information.

2. The UE of claim 1, wherein the first duplex pattern is associated with one or more of downlink sets of symbols, uplink sets of symbols, or SBFD sets of symbols,
wherein the first duplex pattern begins with one of a downlink set of symbols or an SBFD set of symbols, and
wherein the first duplex pattern ends with one of an uplink set of symbols or the SBFD set of symbols.

3. The UE of claim 1, wherein the configuration information indicates the at least one of the first selected TDD pattern or the first selected SBFD pattern by indicating:
a number of downlink slots parameter that indicates a number of downlink slots at a beginning of the first duplex pattern,
a number of downlink symbols parameter that indicates a number of downlink symbols that follow the downlink slots,
a number of uplink slots parameter that indicates a number of uplink slots at an end of the first duplex pattern, and
a number of uplink symbols parameter that indicates a number of uplink symbols that precede the uplink slots.

4. The UE of claim 1, wherein the configuration information indicates the at least one of the at least one of the first selected TDD pattern or the first selected SBFD pattern by indicating:
a starting SBFD slot parameter that indicates a first slot index associated with a starting SBFD slot,
a starting SBFD symbol parameter that indicates a first symbol index of a starting SBFD symbol associated with the starting SBFD slot,
an ending SBFD slot parameter that indicates a second slot index associated with an ending SBFD slot, and
an ending SBFD symbol parameter that indicates a second symbol index of an ending SBFD symbol associated with the ending SBFD slot.

5. The UE of claim 1, wherein the configuration information indicates the at least one of the first selected TDD pattern or the first selected SBFD pattern by indicating:
a number of downlink slots parameter that indicates a number of downlink slots at a beginning of the first duplex pattern,
a number of downlink symbols parameter that indicates a number of downlink symbols that follow the downlink slots,
a starting SBFD symbol parameter that indicates a number of starting SBFD symbols that follow downlink symbols,
a number of SBFD slots parameter that indicates a number of SBFD slots that follow the starting SBFD symbols, and
an ending SBFD slot parameter that indicates a number of ending SBFD symbols that follow the SBFD slots.

6. The UE of claim 1, wherein the configuration information indicates the at least one of the first selected TDD pattern or the first selected SBFD pattern by indicating:
a number of uplink slots parameter that indicates a number of uplink slots at an end of the first duplex pattern,
a number of uplink symbols parameter that indicates a number of uplink symbols that precede the uplink slots,
an ending SBFD slot parameter that indicates a number of ending SBFD symbols that precede the uplink symbols,
a number of SBFD slots parameter that indicates a number of SBFD slots that precede the ending SBFD symbols, and
a starting SBFD symbol parameter that indicates a number of starting SBFD symbols that precede the SBFD slots.

7. The UE of claim 1, wherein the configuration information further indicates a number of guard symbols parameter that indicates at least one of:
a first quantity of guard symbols that follow a last downlink symbol in the at least one of the first selected TDD pattern or the first selected SBFD pattern, or
a second quantity of guard symbols that occur before a first uplink symbol in the at least one of the first selected TDD pattern or the first selected SBFD pattern.

8. The UE of claim 1, wherein the processing system, to cause the UE to receive the configuration information, is configured to cause the UE to receive the configuration information via at least one of a system information block 1 or a cell-specific dedicated configuration.

9. The UE of claim 1, wherein the first duplex pattern is associated with one or more of:
a downlink set of symbols,
a first flexible set of symbols, wherein the first flexible set of symbols is capable of being converted to downlink symbols or SBFD symbols,
an SBFD set of symbols,
a second flexible set of symbols, wherein the second flexible set of symbols is capable of being converted to SBFD symbols or uplink symbols, or
an uplink set of symbols.

10. The UE of claim 9, wherein the configuration information indicates the at least one of the first selected TDD pattern or the first selected SBFD pattern by indicating:
a number of downlink slots parameter that indicates a number of downlink slots at a beginning of the first duplex pattern,
a number of downlink symbols parameter that indicates a number of downlink symbols that follow the downlink slots,
a number of uplink slots parameter that indicates a number of uplink slots at an end of the first duplex pattern,
a number of uplink symbols parameter that indicates a number of uplink symbols that precede the uplink slots,
a starting SBFD slot parameter that indicates a first slot index associated with a starting SBFD slot,
a starting SBFD symbol parameter that indicates a first symbol index of a starting SBFD symbol associated with the starting SBFD slot,
an ending SBFD slot parameter that indicates a second slot index associated with an ending SBFD slot, and
an ending SBFD symbol parameter that indicates a second symbol index of an ending SBFD symbol associated with the ending SBFD slot.

11. The UE of claim 9, wherein the processing system is configured to cause the UE to receive a downlink control information message indicating one or more duplex format indicators (DFIs),
wherein each DFI, of the one or more DFIs, indicates that flexible symbols in a respective slot of the first duplex pattern are to be converted to one of:
downlink symbols,
SBFD symbols, or
uplink symbols.

12. The UE of claim 9, wherein the processing system is configured to cause the UE to receive a downlink control information message indicating one or more duplex format indicators (DFIs),
wherein at least one DFI, of the one or more DFIs, indicates that flexible symbols in a respective slot of the first duplex pattern are to remain flexible symbols.

13. The UE of claim 12, wherein, based at least in part on a predefined rule, the flexible symbols associated with the at least one DFI are associated with one of:
symbols in which no uplink transmissions and no downlink transmissions are permitted to occur,
symbols in which downlink transmissions are permitted to occur and uplink transmissions are not permitted to occur,
symbols in which uplink transmissions are permitted to occur and downlink transmissions are not permitted to occur, or
symbols in which semi-statically scheduled communications are not permitted to occur.

14. The UE of claim 1, wherein the configuration information further indicates a second duplex pattern associated with the network node,
wherein the second duplex pattern is associated with the format capable of being configured as one or more of TDD patterns or SBFD patterns, and
wherein the configuration information indicates, as the second duplex pattern, at least one of a second selected TDD pattern associated with the network node or a second selected SBFD pattern associated with the network node.

15. The UE of claim 14, wherein, based at least in part on a pre-defined rule, one of:
the first duplex pattern and the second duplex pattern are associated with a semi-static duplex pattern,
the first duplex pattern and the second duplex pattern are associated with a dynamic duplex pattern, or
the first duplex pattern is associated with a semi-static duplex pattern and the second duplex pattern is associated with a dynamic duplex pattern.

16. The UE of claim 14, wherein, based at least in part on a predefined rule, one of:
the first duplex pattern is associated with the first selected SBFD pattern and the second duplex pattern is associated with the second selected TDD pattern,
the first duplex pattern is associated with the first selected SBFD pattern and the second duplex pattern is associated with the second selected SBFD pattern, or
the first duplex pattern is associated with the one of the first selected TDD pattern or the first selected SBFD pattern independently of whether the second duplex pattern is associated with the one of the second selected TDD pattern or the second selected SBFD pattern, and the second duplex pattern is associated with the one of the second selected TDD pattern or the second selected SBFD pattern independently of whether the first duplex pattern is associated with the one of the first selected TDD pattern or the first selected SBFD pattern.

17. A network node, comprising:
a processing system that includes one or more processors and one or more code-storing memories coupled with the one or more processors, the processing system configured to cause the network node to:
transmit, to a user equipment (UE), configuration information indicating a first duplex pattern associated with the network node,
wherein the first duplex pattern is associated with a format capable of being configured as one or more of time division duplex (TDD) patterns or sub-band full duplex (SBFD) patterns, and
wherein the configuration information indicates, as the first duplex pattern, at least one of a first selected TDD pattern associated with the network node or a first selected SBFD pattern associated with the network node; and
communicate with the UE based at least in part on the configuration information.

18. The network node of claim 17, wherein the first duplex pattern is associated with one or more of downlink sets of symbols, uplink sets of symbols, or SBFD sets of symbols,
wherein the first duplex pattern begins with one of a downlink set of symbols or an SBFD set of symbols, and
wherein the first duplex pattern ends with one of an uplink set of symbols or the SBFD set of symbols.

19. The network node of claim 17, wherein the configuration information indicates the at least one of the first selected TDD pattern or the first selected SBFD pattern by indicating:
a number of downlink slots parameter that indicates a number of downlink slots at a beginning of the first duplex pattern,
a number of downlink symbols parameter that indicates a number of downlink symbols that follow the downlink slots,
a number of uplink slots parameter that indicates a number of uplink slots at an end of the first duplex pattern, and
a number of uplink symbols parameter that indicates a number of uplink symbols that precede the uplink slots.

20. The network node of claim 17, wherein the configuration information indicates the at least one of the at least one of the first selected TDD pattern or the first selected SBFD pattern by indicating:
a starting SBFD slot parameter that indicates a first slot index associated with a starting SBFD slot,
a starting SBFD symbol parameter that indicates a first symbol index of a starting SBFD symbol associated with the starting SBFD slot,
an ending SBFD slot parameter that indicates a second slot index associated with an ending SBFD slot, and
an ending SBFD symbol parameter that indicates a second symbol index of an ending SBFD symbol associated with the ending SBFD slot.

21. The network node of claim 17, wherein the configuration information indicates the at least one of the first selected TDD pattern or the first selected SBFD pattern by indicating:
a number of downlink slots parameter that indicates a number of downlink slots at a beginning of the first duplex pattern,
a number of downlink symbols parameter that indicates a number of downlink symbols that follow the downlink slots,
a starting SBFD symbol parameter that indicates a number of starting SBFD symbols that follow downlink symbols,
a number of SBFD slots parameter that indicates a number of SBFD slots that follow the starting SBFD symbols, and
an ending SBFD slot parameter that indicates a number of ending SBFD symbols that follow the SBFD slots.

22. The network node of claim 17, wherein the configuration information indicates the at least one of the first selected TDD pattern or the first selected SBFD pattern by indicating:
a number of uplink slots parameter that indicates a number of uplink slots at an end of the first duplex pattern,
a number of uplink symbols parameter that indicates a number of uplink symbols that precede the uplink slots,
an ending SBFD slot parameter that indicates a number of ending SBFD symbols that precede the uplink symbols,
a number of SBFD slots parameter that indicates a number of SBFD slots that precede the ending SBFD symbols, and
a starting SBFD symbol parameter that indicates a number of starting SBFD symbols that precede the SBFD slots.

23. The network node of claim 17, wherein the configuration information further indicates a number of guard symbols parameter that indicates at least one of:
a first quantity of guard symbols that follow a last downlink symbol in the at least one of the first selected TDD pattern or the first selected SBFD pattern, or
a second quantity of guard symbols that occur before a first uplink symbol in the at least one of the first selected TDD pattern or the first selected SBFD pattern.

24. The network node of claim 17, wherein the processing system, to cause the network node to transmit the configuration information, is configured to cause the network node to transmit the configuration information via at least one of a system information block 1 or a cell-specific dedicated configuration.

25. The network node of claim 17, wherein the first duplex pattern is associated with one or more of:
a downlink set of symbols,
a first flexible set of symbols, wherein the first flexible set of symbols is capable of being converted to downlink symbols or SBFD symbols,
an SBFD set of symbols,
a second flexible set of symbols, wherein the second flexible set of symbols is capable of being converted to SBFD symbols or uplink symbols, or
an uplink set of symbols.

26. The network node of claim 25, wherein the configuration information indicates the at least one of the first selected TDD pattern or the first selected SBFD pattern by indicating:
a number of downlink slots parameter that indicates a number of downlink slots at a beginning of the first duplex pattern,
a number of downlink symbols parameter that indicates a number of downlink symbols that follow the downlink slots,
a number of uplink slots parameter that indicates a number of uplink slots at an end of the first duplex pattern,
a number of uplink symbols parameter that indicates a number of uplink symbols that precede the uplink slots,
a starting SBFD slot parameter that indicates a first slot index associated with a starting SBFD slot,
a starting SBFD symbol parameter that indicates a first symbol index of a starting SBFD symbol associated with the starting SBFD slot,
an ending SBFD slot parameter that indicates a second slot index associated with an ending SBFD slot, and
an ending SBFD symbol parameter that indicates a second symbol index of an ending SBFD symbol associated with the ending SBFD slot.

27. The network node of claim 25, wherein the processing system is configured to cause the network node to transmit, to the UE, a downlink control information message indicating one or more duplex format indicators (DFIs),
wherein each DFI, of the one or more DFIs, indicates that flexible symbols in a respective slot of the first duplex pattern are to be converted to one of:
downlink symbols,
SBFD symbols, or
uplink symbols.

28. The network node of claim 25, wherein the processing system is configured to cause the network node to transmit, to the UE, a downlink control information message indicating one or more duplex format indicators (DFIs),
wherein at least one DFI, of the one or more DFIs, indicates that flexible symbols in a respective slot of the first duplex pattern are to remain flexible symbols.

29. A method of wireless communication performed by a user equipment (UE), comprising:
receiving configuration information indicating a first duplex pattern associated with a network node,
wherein the first duplex pattern is associated with a format capable of being configured as one or more of time division duplex (TDD) patterns or sub-band full duplex (SBFD) patterns, and
wherein the configuration information indicates, as the first duplex pattern, at least one of a first selected TDD pattern associated with the network node or a first selected SBFD pattern associated with the network node; and
communicating with the network node based at least in part on the configuration information.

30. A method of wireless communication performed by a network node, comprising:
transmitting, to a user equipment (UE), configuration information indicating a first duplex pattern associated with the network node,
wherein the first duplex pattern is associated with a format capable of being configured as one or more of time division duplex (TDD) patterns or sub-band full duplex (SBFD) patterns, and
wherein the configuration information indicates, as the first duplex pattern, at least one of a first selected TDD pattern associated with the network node or a first selected SBFD pattern associated with the network node; and
communicating with the UE based at least in part on the configuration information.
